(19) United States
(12) Patent Application Publication
(10) Pub. No.: US 2026/0119836 A1
(43) Pub. Date: Apr. 30, 2026

(54) METHOD FOR INTERPRETING GRAPH NEURAL NETWORK BASED ON FPGA ACCELERATION

(71) Applicant: ZHEJIANG LAB, Hangzhou City (CN)

(72) Inventors: Ting JIANG, Hangzhou (CN); Zechuan ZHANG, Hangzhou (CN); Yu ZHANG, Hangzhou (CN); Ting YU, Hangzhou (CN); Hao QI, Hangzhou (CN); Ji ZHANG, Hangzhou (CN)

(73) Assignee: ZHEJIANG LAB, Hangzhou City (CN)

(21) Appl. No.: 19/433,722

(22) Filed: Dec. 27, 2025

Related U.S. Application Data
(63) Continuation of application No. PCT/CN2023/139066, filed on Dec. 15, 2023.

(51) Int. Cl. G06N 3/042; G06F 17/16; G06N 3/08

(52) U.S. Cl. CPC G06N 3/042; G06F 17/16; G06N 3/08

(57) ABSTRACT

A method and device for interpreting a graph neural network based on FPGA acceleration propose to use FPGA hardware to accelerate interpretation process of the graph neural network oriented to node classification in parallel, and improve node traversal and shortest path search of BFS, thereby optimizing requirements of algorithm calculation and storage, and accelerating generation of interpretation results. During calculating HN values, the present disclosure optimizes multiplication operation using the matrix characteristics, transforms the dense matrix multiplication into sparse-dense matrix multiplication, and optimizes the resource occupation using multi-PE parallel processing, greatly improving performance of graph neural network interpretation acceleration. Moreover, an overall architecture based on FIFO storage calculation task distribution is designed to reduce calculation difference between nodes, solving the difficulty of high time complexity of the graph neural network interpretation method based on node classification in actual data applications and improving the time efficiency of interpretation.

### CROSS-REFERENCE TO RELATED APPLICATIONS

The present application is a continuation of International Application No. PCT/CN2023/139066, filed on Dec. 15, 2023, the content of which is incorporated herein by reference in its entirety.

### TECHNICAL FIELD

The present disclosure relates to the technical field of graph neural network interpretation, and in particular, to a method and device for interpreting a graph neural network based on FPGA acceleration.

### BACKGROUND

Graph neural network shows good performance in many scientific fields, such as natural language processing, computer vision, biology, social networking and so on. Graph neural network has been widely used in different graph tasks, such as node classification, graph classification and so on, because of its good direct inference ability and high efficiency. However, when using graph neural network to solve these problems, it is often regarded as a complex and opaque method. With the gradual improvement of our requirements for the safety, credibility and performance of graph neural network, it is very important to explain graph neural network.

The first interpretation method specially designed for the graph neural network is GNNExplainer, which is a model-independent and universal graph neural network explainer, and its main purpose is to extract important edges and features as model interpretations; later, PGExplainer used the method of parametric learning to explain the generation process, and realized the simultaneous interpretation of multiple instances. These classical methods pay more attention to the interpretation of the feature dimension of nodes or edges, and the substructure of graphs has not been mentioned. Subgraphx puts forward the method of interpreting the graph neural network with subgraphs, which explains the graph neural network more intuitively and has excellent explanatory performance.

The above classical algorithms perform well in graph classification, but few algorithms pay attention to node classification, and use actual data to verify the effect of the algorithm. Moreover, the interpretation algorithm that pays attention to the node classification problem is too complicated in time in actual data to give the interpretation result quickly. FPGA has the characteristics of high programmable flexibility, short development cycle and high parallel computing efficiency, which can accelerate the algorithm in practical applications.

### SUMMARY

In view of the shortcomings of the prior art, the object of the present disclosure is to provide a method and device for interpreting a graph neural network based on FPGA acceleration.

The object of the present disclosure is achieved through the following technical solution: a method for interpreting a graph neural network based on FPGA acceleration includes the following steps:
(1) Acquiring a target data set and dividing the target data set into a training set and a test set.
(2) Training the graph neural network using the training set to obtain a trained graph neural network; classifying each test node in the test set using the trained graph neural network to obtain a test prediction label set.
(3) For each test node in the test set, obtaining a k-hop neighbor node set and a subgraph adjacency matrix corresponding to each test node on Field-Programmable Gate Array (FPGA).
(4) For each test node in the test set, acquiring a corresponding explanatory subgraph through the subgraph adjacency matrix corresponding to each test node.

Further, the step (1) further includes: acquiring data of a node classification task scene, and constructing into a graph G corresponding to the data. The graph G has a total of N nodes, that is, a graph node set V={x₁,x₂, . . . ,xₙ,x_{N}}, where xₙ represents a n^{th} node; dividing the graph node set V into the training set Tᵣ={x̅₁,x̅₂, . . . ,x̅ₚ, . . . , x̅_{P}} and the test set Tₑ={\tilde{x}₁,\tilde{x}₂, . . . ,\tilde{x}_{q}, . . . ,\tilde{x}_{Q}}. The training set Tᵣ has a total of P nodes, and x̅ₚ is any node in the training set Tᵣ, and the test set Tₑ has a total of Q nodes, and \tilde{x}_{q} is any node in the test set Tₑ; and obtaining a real label set Yᵣ={y̅₁,y̅₂, . . . ,y̅ₚ, . . . ,y̅_{P}} corresponding to the training set Tᵣ, where y̅_{P} represents a real label of the node x̅ₚ.

Further, the step (2) further includes the following sub-steps:

2.1) A neighbor node set of any node x̅ₚ, in the training set Tᵣ in the graph G being N(x̅ₚ), receiving, by the node x̅ₚ, a message

$${m}_{u}^{l} = M S G ( {h}_{u}^{l - 1} )$$

propagated by each node

$${\overline{x}}_{u}^{p}$$

in the neighbor node set N(x̅ₚ) in each layer of the graph neural network, where

$${\overline{x}}_{u}^{p} ∈ N ( p ) ,$$

l represents a l^{th} layer of the graph neural network, l=1,2, . . . ,l, . . . , L,

$${h}_{u , p}^{l - 1}$$

represents a feature representation of the node

$${\overline{x}}_{u}^{p}$$

at a l−1th^{th} layer, and

$${h}_{u , p}^{0} = {X}_{u , p}$$

represents an initial feature representation of the node

$${\overline{x}}_{u}^{p} .$$

(2.2) Calculating an aggregated message M_{P}^{l} of the node x̅ₚ at each layer as follows:

$${M}_{p}^{l} = {AGG}_{{\overline{x}}_{u} ∈ N ( p )} ( {m}_{u}^{l} ) ,$$

where AGG(.) represents an aggregate function.

(2.3) Performing, by the graph neural network, nonlinear transformation on the aggregated message

$${M}_{p}^{l}$$

and a feature representation

$${h}_{p}^{l - 1}$$

of the node x̅ₚ at an upper layer to obtain a feature representation

$${h}_{p}^{l}$$

of the node x̅ₚ at the lₜₕ layer, and calculating the feature representation

$${h}_{p}^{l}$$

as follows:

$${h}_{p}^{l} = Updata ( {M}_{p}^{l} , {h}_{p}^{l - 1} ) ,$$

where Update(.) represents an update function.

Obtaining a final embedding of the node x̅ₚ in the graph neural network by

$${z}_{p} = {h}_{p}^{L} .$$

(2.4) Repeating the sub-step (2.1) to the sub-step (2.3) for each node in the training set Tᵣ, to obtain a final embedding set Zᵣ: Zᵣ={z₁, z₂, . . . , zₚ, . . . , z_{P}).

(2.5) Classifying each test node using a fully connected layer according to the final embedding set Zᵣ, and training and optimizing the graph neural network using across entropy loss function, to obtain the trained graph neural network:

$$f ( \cdot ) = V {\to }^{A , X} Y .$$

(2.6) Classifying each node in the test set T using the trained graph neural network to obtain the test prediction label set

$${Y}_{e} = \{ {y}_{1}^{*} , {y}_{2}^{*} , ⋯ , {y}_{q}^{*} , ⋯ , {y}_{Q}^{*} \} ,$$

where

$${y}_{q}^{⋆}$$

represents a prediction label of any test node \tilde{x}_{q} in the test set Tₑ, and calculating

$${y}_{q}^{*}$$

as follows:

$${y}_{q}^{*} = argmax [ f ( {\tilde{x}}_{q} ) ] .$$

Further, the step (3) further includes the following sub-steps:

(3.1) Acquiring an adjacency matrix A and a k-order adjacency matrix A^{k} of the graph G, where A and A^{k} are represented as follows:

$$A = [ \begin{matrix}{a}_{1 , 1} & ⋯ & ⋯ & ⋯ & {a}_{1 , i} & ⋯ & {a}_{1 , N} \\ ⋮ & ⋱ & ⋯ & ⋯ & ⋯ & ⋯ & ⋮ \\ {a}_{j , 1} & ⋯ & {a}_{j , j} & ⋯ & {a}_{j , i} & ⋯ & {a}_{j , N} \\ ⋮ & ⋯ & ⋯ & ⋱ & ⋯ & ⋯ & ⋮ \\ ⋮ & ⋯ & ⋯ & ⋯ & ⋱ & ⋯ & ⋮ \\ ⋮ & ⋯ & ⋯ & ⋯ & ⋯ & ⋱ & ⋮ \\ {a}_{N , 1} & ⋯ & {a}_{N , j} & ⋯ & {a}_{N , i} & ⋯ & {a}_{N , N}\end{matrix} ] , and$$

$${A}^{k} = [ \begin{matrix}{a}_{1 , 1}^{k} & ⋯ & ⋯ & ⋯ & {a}_{1 , i}^{k} & ⋯ & {a}_{1 , N}^{k} \\ ⋮ & ⋱ & ⋯ & ⋯ & ⋯ & ⋯ & ⋮ \\ {a}_{j , 1}^{k} & ⋯ & {a}_{j , j}^{k} & ⋯ & {a}_{j , i}^{k} & ⋯ & {a}_{j , N}^{k} \\ ⋮ & ⋯ & ⋯ & ⋱ & ⋯ & ⋯ & ⋮ \\ ⋮ & ⋯ & ⋯ & ⋯ & ⋱ & ⋯ & ⋮ \\ ⋮ & ⋯ & ⋯ & ⋯ & ⋯ & ⋱ & ⋮ \\ {a}_{N , 1}^{k} & ⋯ & {a}_{N , j}^{k} & ⋯ & {a}_{N , i}^{k} & ⋯ & {a}_{N , N}^{k}\end{matrix} ] ,$$

where a_{j,i} represents any element in the adjacency matrix A, j represents a first number of the element a_{j,i} and i represents a second number of the element a_{j,i}, a_{j,i} indicates whether j^{th} node xⱼ and an i^{th} node xᵢ in the graph G are connected with each other, and the value of the element a_{j,i} is 1 when the j^{th} node xⱼ and the i^{th} node xᵢ are connected with each other, otherwise the value of the element a_{j,i} 0;

$${a}_{j , i}^{k}$$

indicates whether the j^{th} node xⱼ and the i^{th} node xᵢ are connected with each other through at most k−1 intermediate nodes, when the j^{th} node xⱼ and the i^{th} node xᵢ are connected with each other through at most k−1 intermediate nodes, the value of

$${a}_{j , i}^{k}$$

is 1, and the i^{th} node xᵢ is a k-hop neighbor node of the j^{th} node xⱼ, otherwise, the value of

$${a}_{j , i}^{k}$$

is 0; and j^{th} row in the k-order adjacency matrix A^{k} is a row where the node xⱼ is located, and j^{th} column in the k-order adjacency matrix A^{k} is a column where the node xⱼ is located.

Writing the adjacency matrix A and k-order adjacency matrix A^{k} of the graph G into DDR4 storage outside FPGA; and providing a FIFO-cnt counter and six preprocessing units.

(3.2) Selecting any six test nodes from the test set Tₑ, and allocating a corresponding preprocessing unit to any one test node, respectively; scanning, by each preprocessing unit, the row of the respective test node from the k-order adjacency matrix A^{k} of the graph G to obtain row data of the test nodes and to determine a number of k-hop neighbor nodes for the respective test node.

Sorting the obtained numbers of the k-hop neighbor nodes of the six test nodes in a descending order. A test node with a larger number of k-hop neighbor nodes is given priority in sub-step (3.3), and when the number of k-hop neighbor nodes is the same, a test node with a smaller serial number is given priority in sub-step (3.3).

(3.3) Setting eight segment traversal units, dividing evenly the row data obtained by scanning the test nodes into eight segments, distributing the eight segments to the eight segment traversal units in turn. Each segment traversal unit has a write initiation application and a write enable response; and controlling, by an arbiter, applications initiated by the eight segment traversal units for round-robin arbitration, traversing, by each segment traversal unit, the allocated row data, finding the test nodes corresponding to second numbers of all elements with an element value of 1 in the graph G as the k-hop neighbor nodes of the test nodes, to obtain the k-hop neighbor node set of the test nodes.

Intercepting the k-order adjacency matrix A^{k} of the graph G by the k-hop neighbor node set of the test nodes, including: intercepting the corresponding row data from the k-order adjacency matrix of the graph G according to the number of each k-hop neighbor node to obtain a row matrix of the test nodes; and intercepting the corresponding column data from the row matrix of the test nodes according to the number of each k-hop neighbor node to obtain the subgraph adjacency matrix of the test nodes.

(3.4) Performing the sub-step (3.3) on the six test nodes in turn to obtain the corresponding k-hop neighbor node set and the subgraph adjacency matrix, respectively.

(3.5) Selecting any six test nodes from the remaining test nodes in the test set Tₑ, repeating the sub-step (3.1) to the sub-step (3.4) until each test node in the test set Tₑ obtains the respective k-hop neighbor node set and the respective subgraph adjacency matrix, and obtaining a subgraph adjacency matrix set

$$\{ {A}_{sub}^{1} , {A}_{sub}^{2} , … , {A}_{sub}^{q} , … , {A}_{sub}^{Q} \} ,$$

where

$${A}_{sub}^{q}$$

represents the subgraph adjacency matrix corresponding to the test node \tilde{x}_{q}.

Further, the step (4) further includes the following sub-steps:

(4.1) When the number

$${N}_{q}^{k}$$

of k-hop neighbor nodes of any test node \tilde{x}_{q} in the test set is not more than m, performing a corresponding HN table operation on the subgraph adjacency matrix

$${A}_{sub}^{q}$$

of the test node \tilde{x}_{q} including:

(c1) Acquiring a connectivity result set of all permutations and combinations of nodes in the k-hop neighbor node set of the test node \tilde{x}_{q} in FPGA hardware to obtain a matrix P̅_{q}.

(c2) Optimizing the calculation of (H_{q})⁴ by taking (H_{q})⁴ as an iterative convergence value of H_{q}, dividing (H_{q})⁴ into cubic sparse-dense matrix multiplication and quadratic dense matrix multiplication using an idempotent property, namely, (P̅_{q})²=P̅_{q} and (H_{q})²=(P̅_{q}M_{q})P̅_{q}(M̅_{q}P̅_{q}), of the matrix P̅_{q}. The sparse-dense matrix multiplication assigns tasks to elements with an element value of 1 in a sparse matrix, and adopts direct static mapping from matrix rows to eight PEs to increase parallel calculation of the FPGA hardware, each PE is assigned multiple rows with intervals between them, and the elements with the element value of 1 are searched among the rows in a round-robin manner, to prevent the sparse matrix from gathering in some rows, and multiple rows of data to be processed are effectively connected.

(c3) Pre-calculating eigenvalue results of all node combination arrangements according to a node number in the subgraph adjacency matrix of the test node \tilde{x}_{q}, and splicing the eigenvalue results into an eigenvalue vector v̅_{q} according to an arrangement combination of single node, double nodes, . . . , and m nodes.

Calculating the eigenvalue results of any node combination arrangement o by the following equation:

$$\overline{v} = [ f ( {G}_{sub}^{q} ) ] {\_y}_{q}^{*} \_o - {f\_y}_{q}$$

where

$$[ f ( {G}_{sub}^{q} ) ] {\_y}_{q}^{*} \_o$$

represents a probability average that all nodes in the node combination arrangement o are predicted to be

$${y}_{q}^{*} ; and {f\_y}_{q}^{*}$$

represents a probability average that all nodes in the graph G are predicted to be

$${y}_{q}^{⋆} .$$

Obtaining an HN value matrix vector \tilde{v}_{q} by \tilde{v}_{q}=(H_{q})⁴*v̅_{q}, taking the first

$${N}_{q}^{k}$$

values in the HN value matrix vector \tilde{v}_{q} as HN values of

$${N}_{q}^{k}$$

nodes in the k-hop neighbor node set of the test node \tilde{x}_{q}, respectively, to obtain an HN table of the subgraph adjacency matrix

$${A}_{sub}^{q}$$

of the test node \tilde{x}_{q}, namely an explanatory subgraph of the test node \tilde{x}_{q}.

(4.2) When the number

$${N}_{q}^{k}$$

of k-hop neighbor nodes of any test node \tilde{x}_{q} in the test set is greater than m, sampling the subgraph adjacency matrix

$${A}_{sub}^{q}$$

of the test node \tilde{x}_{q} layer by layer on FPGA based on a central node to obtain a sampling graph adjacency matrix set

$$\{ {A}_{MC \_ 1}^{q} , {A}_{MC \_ 2}^{q} , ⋯ , {A}_{MC \_ {N}_{q}^{k}}^{q} \}$$

of the test node \tilde{x}_{q}.

Performing a corresponding HN table operation for each sampling diagram adjacency matrix in the sampling diagram adjacency matrix set to obtain the HN table corresponding to each sampling diagram adjacency matrix; and a HN value of each node in the subgraph adjacency matrix

$${A}_{sub}^{q}$$

of the test node \tilde{x}_{q} being an average of the HN values in different sampling graph adjacency matrices, and obtaining the explanatory subgraph of the test node \tilde{x}_{q}.

(4.3) Repeating the sub-step (4.1) or the sub-step (4.2) for each test node according to the number of k-hop neighbor nodes of each test node in the test set, to obtain the explanatory subgraph corresponding to each test node in the test set.

Further, the sub-step (4.2) further includes the following sub-steps:

(4.2.1) When the number

$${N}_{q}^{k}$$

of the k-hop neighbor nodes of the test node \tilde{x}_{q} is greater than m, for the subgraph adjacency matrix

$${A}_{sub}^{q}$$

of the test node \tilde{x}_{q}, traversing shortest path of the subgraph adjacency matrix

$${A}_{sub}^{q}$$

of the test node \tilde{x}_{q} by taking the test node \tilde{x}_{q} as a target node.

(4.2.2) While traversing the shortest path of the subgraph adjacency matrix

$${A}_{sub}^{q}$$

of the test node \tilde{x}_{q} generating synchronously the sampling graph node set to obtain the sampling graph adjacency matrix set

$$\{ {A}_{MC \_ 1}^{q} , {A}_{MC \_ 2}^{q} , ⋯ , {A}_{MC \_ {N}_{q}^{k}}^{q} \}$$

of the test node \tilde{x}_{q}.

(4.2.3) Performing the corresponding HN table operation for each sampling diagram adjacency matrix in the sampling diagram adjacency matrix set to obtain the HN table corresponding to each sampling diagram adjacency matrix; and the HN value of each node in the subgraph adjacency matrix

$${A}_{sub}^{q}$$

of the test node \tilde{x}_{q} being an average of the HN values in different sampling graph adjacency matrices, and obtaining the explanatory subgraph of the test node \tilde{x}_{q}.

Further, the sub-step (4.2.1) further includes the following sub-steps:

(a1) Performing traversal initialization, including: initializing node on an FPGA to a list with all element values being 0 and a length of

$${N}_{q}^{k}$$

by

$$node = [ node ( 1 ) , … , node ( c ) , … , node ( {N}_{q}^{k} ) ] = [ 0 , … , 0 ] ,$$

identifying, by the list node, whether the target \tilde{x}_{q} has been accessed, where node(c) represents the element value of a c^{th} element in the list node; initializing flag to a queue including only the number of the target node in the graph node set V by flag=[flag(1)]=[q′], storing, by the queue flag, the neighbor node numbers obtained by BFS after each node traversal, where flag(1) represents the element value of a first element in the list flag, and q′ represents the number of the target node \tilde{x}_{q} in the graph node set V; initializing node_flag to a list with an element value of 1 for a q^{th} element and element values of 0 for other elements as well as a length of

$${N}_{q}^{k}$$

by node_flag=[node_flag(1), . . . ,node_flag(c), . . . ,node_flag(7)], identifying, by the list node_flag, whether the target node \tilde{x}_{q} already exists in the flag, where node_flag(c) represents the element value of the c^{th} element in the list node_flag, and node_flag(q)=1; initializing node_f to a list with all element values being −1 and a length of

$${N}_{q}^{k}$$

by

$$node\_f = [ node\_f ( 1 ) , … , node\_f ( c ) , … , node\_f ( {N}_{q}^{k} ) ] = [ - 1 , … , - 1 ] ,$$

identifying, by the list node_f, a predecessor node of the node traversal process, where node_f(c) represents the element value of the c^{th} element in the list node_f; initializing bfs_cnt=0 to control a subscript address of the queue flag for each access; and initializing node_pate to a list containing

$${N}_{q}^{k}$$

sub-lists by node_pate=[node_pate [1], . . . ,node_pate [E], . . . ,

$$node\_pate [ {N}_{q}^{k} ] ] ,$$

where node_pate [E] represents an E^{th} sub-list in the list node_pate, and each sub-list includes

$${N}_{q}^{k}$$

elements with all element values being 0, respectively.

(a2) After traversal initialization, performing access according to the value of bfs_cnt to obtain the element value of a bfs_cnt^{th} element in the listflag:flag(bfs_cnt); updating the list node, assigning the element value of a flag(bfs_cnt)^{th} element in the list node with 1, and taking a node x_{flag(bfs_cnt)} as a current traversal target node, and determining whether the element value of theflag(bfs_cnt)^{th} element in a list node_f is −1, when the element value is −1, predecessor node of the current traversal target node being invalid, and reading a flag(bfs_cnt)^{th} row of the subgraph adjacency matrix

$${A}_{sub}^{q}$$

to obtain row data, and skipping to step (a3) to update limited node information; when the element value is not −1, the predecessor node of the current traversal target node being valid, and updating the list node_pate: registering the path information from the current traversal target node to the target node into the list node_pate, and reading theflag(bfs_cnt)th row of the subgraph adjacency matrix

$${A}_{sub}^{q}$$

to obtain row data, and skipping to step (a3) to update the limited node information.

(a3) Traversing the read row data for effective elements, including: reading the row data to obtain a second number of a first element with an element value of 1 as h, when the second number h is the same as the element value of any one element in the list flag, reading the row data to obtain the second number of a next element with an element value of 1; when the second number h is different from the element value of any one element in the list flag, updating the listflag: adding the second number h to the list flag to obtain the updated listflag is flag=[fag(1), fag(1)]=[M,h], and updating the list node_fag: giving the element value of the h^{th} element in the list node_fag to 1, and recording the predecessor node of a node xₕ as the current traversal target node and updating the list node_f assigning the element value of the h^{th} element in the list node_f to the number M of the current traversal target node, reading the row data to obtain the second number of the next element with an element value of 1, and repeating the above steps until the element with an element value of 1 is not capable of being read from the row data, and ending traversing.

After traversing, updating the value of bfs_cnt by bfs_cnt=bfs_cnt+1; repeating step (a2) according to the updated value of bfs_cnt until the updated value of bfs_cnt is

$${N}_{q}^{k} + 1 ,$$

jumping to an idle state to complete the shortest path traversal of the subgraph adjacency matrix

$${A}_{sub}^{q}$$

of the test node \tilde{x}_{q} to obtain the updated list node_pate.

Further, the step (4.2.2) further includes the following sub-steps:

(b1) Performing sample initialization, including: initializing node_out to a list including

$${N}_{q}^{k}$$

sub-lists

$$node\_out = [ node\_out [ 1 ] , … , node\_out [ D ] , … , node\_out [ {N}_{q}^{k} ] ] ,$$

where node_out[D] represents a D^{th} sub-list in the list node_out, and each sub-list includes m, respectively, and all element values are null; and initializing node_y to a list with all element values being 0 and a length of

$${N}_{q}^{k}$$

by

$$node\_y = [ node\_y ( 1 ) , … , node\_y ( c ) , … , node\_y ( {N}_{q}^{k} ) ] = [ 0 , … , 0 ] , \qquad ( 1 )$$

where node_y(c) represents the element value of the c^{th} element in the list node_y.

(b2) After sampling initialization, detecting the number of elements in the list flag at any time, including: when detecting that the number of elements in the list flag is m, obtaining a set of m nodes closest to the test node \tilde{x}_{q}, and skipping to step (b3).

(b3) Updating the list node_out to obtain the updated list node_out by node_out=[[x_{flag(1)}, x_{flag(2)}, . . . ,x_{flag(m)}], . . . , [x_{flag(1)},x_{flag(2)}, . . . , x_{flag(m)}]].

(b4) Updating the updated value of bfs_cnt at any time after traversing. When the updated value of node_out is m+1, m nodes have been traversed in the traversal process of the shortest path; and skipping to step (b5).

(b5) Updating the list node_y, including: covering each element value in the updated list node at this time after traversing with each element value in the list node_y.

(b6) After traversing the shortest path of the subgraph adjacency matrix

$${A}_{s u b}^{q}$$

of the test node \tilde{x}_{q}, processing the updated list node_pate, including: assigning the element value of the D^{th} element in the D^{th} subgraph of the list node_pate with 1, and performing the above operations for each subgraph; and obtaining the number of the elements whose element value is 0 in the list node_y: u₁, . . . ,u_{z}, . . . .

Performing sequentially the following processes on each obtained number: calculating the number of elements with an element value of 1 in a u_{z}^{th} row in the list node_pate as num_u_{z} corresponding to any number u_{z}; obtaining a set of samplable nodes, node_pate{u_{z}}′, of the node xᵤ_{_{z}} outside the shortest path node and closest to the test node \tilde{x}_{q} through combinatorial logic (node_pate{u_{z}}& node_y)∧node_y, where node_pate{u_{z}} represents the row data of the U, th row in the list node_pate, & represents an AND operator, and ∧ represents an XOR operator; reserving arbitrarily m-num_u_{z}elements from the samplable node set node_pate{u_{z}}′ of the node xᵤ_{_{z}}, to have an element value of 1, and covering the remaining nodes with the element value from 1 to 0, obtaining a second samplable node set node_pate {u_{z}} of the node xᵤ_{_{z}}, and performing an OR operation on the second samplable node setnode_pate{u_{z}}″ and node_pate{u_{z}} to obtain a sampling node set node_pate{u_{z}} of the node xᵤ_{_{z}}; updating the list node_out: covering sequentially the number corresponding to the element with an value of 1 in the sampling node set of the node xᵤ_{_{z}} with the number of each element in the u_{z}^{th} row of the list node_out.

Completing the processing of each obtained number to obtain a sampled list node_out.

(b7) Performing an adjacency matrix interception operation on the subgraph adjacency matrix

$${A}_{s u b}^{q}$$

of the test node \tilde{x}_{q} by taking each row of data in the sampled list node_out as the sampling neighbor node set of the test node \tilde{x}_{q} to obtain

$${N}_{q}^{k}$$

sampling graph adjacency matrices, and obtaining the sampling graph adjacency matrix set

$$\{ {A}_{MC \_ 1}^{q} , {A}_{MC \_ 2}^{q} , … , {A}_{{MC \_ N}_{q}^{k}}^{q} \}$$

of the test node \tilde{x}_{q}.

The preset disclosure further provides a device for interpreting a graph neural network based on FPGA acceleration, including one or more processors for implementing the above method for interpreting a graph neural network based on FPGA acceleration.

The preset disclosure further provides a non-transitory computer-readable storage medium on which a program is stored. When executed by a processor, the program is configured to implement the above method for interpreting a graph neural network based on FPGA acceleration.

Compared to the related art, the present disclosure has the following beneficial effects:
(1) The present disclosure uses FPGA hardware to accelerate the interpretation process of the graph neural network, thereby solving the high time complexity in the interpretation of graph neural network node classification results, solving the big data in practical application scenarios, and expanding the practical application scenarios of interpreting the graph neural network.
(2) The present disclosure prioritizes pre-computing eigenvalues for all permutation combinations of the node sets, avoiding the repeated calculation of the permutation sets of many nodes caused by the mutually adjacent relationship between different test nodes, and thereby improving the calculation efficiency.
(3) The present disclosure implements an improved BFS algorithm on FPGA hardware, optimizing the method of calculating the shortest path based on complete predecessor nodes obtained after the operation of the algorithm. This optimization is achieved through the combinational logic operation of nodes and related arrays, thereby improving computational and storage efficiency and accelerating the generation of interpretation results.
(4) The present disclosure is beneficial to the optimization processing of multiplication operations by matrix characteristics, and dense matrix multiplication is converted into sparse-dense matrix multiplication, and the resource occupation is optimized by using multi-PE parallel processing, thereby significantly enhancing the performance of graph neural network interpretation acceleration.
(5) The present disclosure designs an overall architecture based on FIFO to store calculation tasks and dynamically distribute them to run the sub-steps of the above interpretation method, thereby optimizing the unbalanced in computation among nodes.

### BRIEF DESCRIPTION OF DRAWINGS

FIG. 1 is a schematic flow chart of a method for interpreting a graph neural network based on FPGA acceleration;

FIG. 2 is a schematic diagram of a graph G in Embodiment 1;

FIG. 3 is a flow chart of the operation of 8 segment traversal units;

FIG. 4 is a schematic diagram of the iterative calculation process of H_{q}; and

FIG. 5 is a structural diagram of a device for interpreting a graph neural network based on FPGA acceleration.

### DESCRIPTION OF EMBODIMENTS

In order to make the purpose, technical solution and advantages of the present disclosure more clear, the present disclosure will be further described in detail with the attached drawings and examples. It should be understood that the specific examples described here are only for interpreting the present disclosure, not all the embodiments. Based on the embodiments in the present disclosure, all other embodiments obtained by those skilled in the art without creative labor are within the protection scope of the present disclosure.

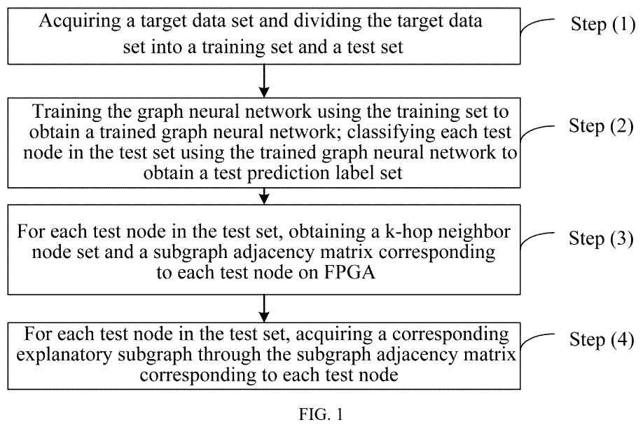

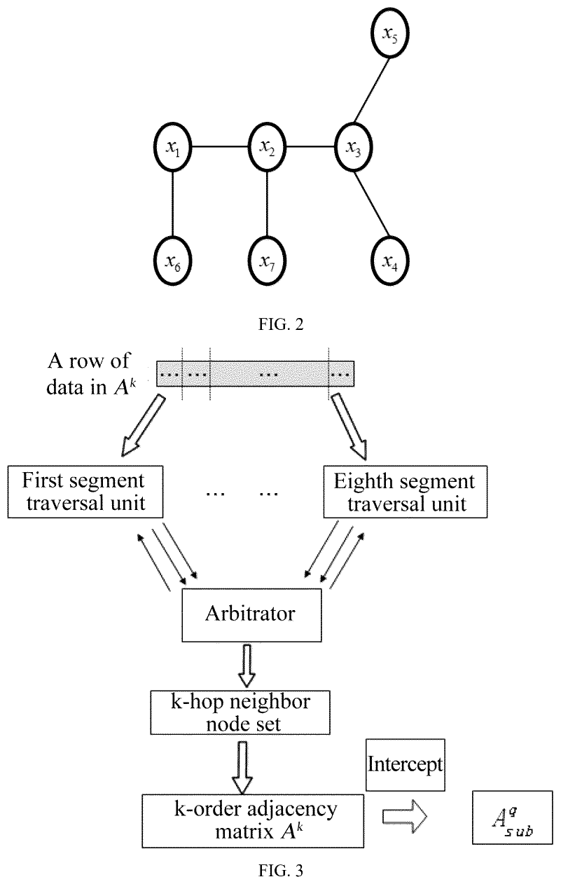

Embodiment 1: as shown in FIG. 1, the present disclosure provides a method for interpreting the graph neural network based on FPGA acceleration, which includes the following steps:

(1) Acquiring a target data set and dividing the target data set into a training set and a test set.

The present disclosure focuses on node classification tasks, including node classification task scenarios in social networks and citation networks.

The step (1) specifically includes the following steps: acquiring data of a node classification task scene, and constructing into a graph G corresponding to the data. The graph G has a total of N nodes, that is, a graph node set V={x₁, x₂, . . . ,xₙ, . . . ,x_{N}}, where xₙ represents a n^{th} node, and n={1,2, . . . , n, . . . , N}; dividing the graph node set V into the training set Tᵣ={x̅₁, x̅₂, . . . , x̅ₚ, x̅_{P}} and the test set Tₑ={\tilde{x}₁, \tilde{x}₂, . . . , \tilde{x}_{q}, . . . , \tilde{x}_{Q}}. The training set Tᵣ has a total of P nodes, p=1,2, . . . , p, . . . , P, and x̅ₚ is any node in the training set Tᵣ and the test set Tₑ has a total of Q nodes, q=1,2, . . . ,q, . . . ,Q, and \tilde{x}_{q} is any node in the test set Tₑ; and obtaining a real label set Yᵣ={y̅₁, y̅₂, . . . , y̅ₚ, . . . , y̅_{P}} corresponding to the training set Tᵣ, where y̅ₚ represents a real label of the node x̅ₚ;

(2) Training the graph neural network using the training set to obtain a trained graph neural network; and classifying each test node in the test set using the trained graph neural network to obtain a test prediction label set.

In this embodiment, the graph neural network takes GraphSAGE as an example.

The step (2) specifically includes the following sub-steps:

(2.1) A neighbor node set of any node x̅ₚ in the training set Tᵣ in the graph G being N(x̅ₚ),receiving, by the node x̅ₚ, a message

$${m}_{u}^{l} = M S G ( {h}_{u}^{l - 1} )$$

propagated by each node

$${\overline{x}}_{u}^{p}$$

in the neighbor node set N(x̅ₚ) in each layer of the graph neural network, where

$${\overline{x}}_{u}^{p} ∈ N ( p ) ,$$

represents a l^{h} layer of the graph neural network, l=1,2, . . . ,l, . . . , L,

$${h}_{u , p}^{l - 1}$$

represents a feature representation of the node

$${\overline{x}}_{u}^{p}$$

at a l-1^{th} layer, and

$${h}_{u , p}^{0} = {X}_{u , p}$$

represents an initial feature representation of the node

$${\overline{x}}_{u}^{p} .$$

In graph G, each node x_{z} propagates its own information to every node connected with it through the edge; in this step, the information of the node itself will be spread to the whole receptive field, which is all the neighbor nodes.

(2.2) Calculating an aggregated message

$${M}_{p}^{l}$$

of the node x̅ₚ at each layer as follows:

$${M}_{p}^{l} = {AGG}_{{x}_{u} ∈ N ( p )} ( {m}_{u}^{l} ) ,$$

where AGG(.) represents an aggregate function. The aggregation function includes summation, averaging or maximizing.

The aggregated information is transformed by nonlinear activation function. The original information aggregation process is generally linear operation and combination of information, and the nonlinear function makes the network obtain stronger fitting ability and enhance the expression ability of the model.

(2.3) Performing, by the graph neural network, nonlinear transformation on the aggregated message

$${M}_{p}^{l}$$

and a feature representation

$${h}_{p}^{l - 1}$$

of the node x̅ₚ at an upper layer to obtain a feature representation

$${h}_{p}^{l}$$

of the node x̅ₚ at the l^{th} layer, and calculating the feature representation

$${h}_{p}^{l}$$

as follows:

$${h}_{p}^{l} = Updata ( {M}_{p}^{l} , {h}_{p}^{l - 1} ) ;$$

where Update(.) represents an update function.

Finally, obtaining a final embedding of the node x̅ₚ in the graph neural network by

$${z}_{p} = {h}_{p}^{L} .$$

(2.4) Repeating the sub-step (2.1) to the sub-step (2.3) for each node in the training set Tᵣ, to obtain a final embedding set Zᵣ: Zᵣ={z₁, z₂, . . . , z, zₚ, . . . z_{P}}.

(2.5) Classifying each test node using a fully connected layer according to Zᵣ={z₁, z₂, . . . , zₚ, . . . z_{P}}, and training and optimizing the graph neural network using across entropy loss function, to obtain the trained graph neural network:

$$f ( \cdot ) = V {\to }^{A , X} Y .$$

(2.6) Classifying each node in the test set Tₑ using the trained graph neural network to obtain the test prediction label set

$${Y}_{e} = \{ {y}_{1}^{*} , {y}_{2}^{*} , … , {y}_{q}^{*} , … , {y}_{Q}^{*} \} ,$$

where

$${y}_{q}^{*}$$

represents a prediction label of any test node \tilde{x}_{q} in the test set Tₑ, and calculating

$${y}_{q}^{*}$$

as follows:

$${y}_{q}^{*} = arg max [ f ( {\tilde{x}}_{q} ) ] .$$

(3) For each test node in the test set, the k-hop subgraph corresponding to each test node in the test set is obtained in parallel by grouping on FPGA.

The step (3) specifically includes the following sub-steps:

(3.1) Acquiring an adjacency matrix A and a k-order adjacency matrix A^{k} of the graph G. A and A^{k} are represented as follows:

$$A = [ \begin{matrix}{a}_{1 , 1} & … & … & … & {a}_{1 , i} & … & {a}_{1 , N} \\ ⋮ & ⋱ & … & … & … & … & ⋮ \\ {a}_{j , 1} & … & {a}_{j , j} & … & {a}_{j , i} & … & {a}_{j , N} \\ ⋮ & … & … & ⋱ & … & … & ⋮ \\ ⋮ & … & … & … & ⋱ & … & ⋮ \\ ⋮ & … & … & … & … & ⋱ & ⋮ \\ {a}_{N , 1} & … & {a}_{N , j} & … & {a}_{N , i} & … & {a}_{N , N}\end{matrix} ] ,$$

$${A}^{k} = [ \begin{matrix}{a}_{1 , 1}^{k} & … & … & … & {a}_{1 , i}^{k} & … & {a}_{1 , N}^{k} \\ ⋮ & ⋱ & … & … & … & … & ⋮ \\ {a}_{j , 1}^{k} & … & {a}_{j , j}^{k} & … & {a}_{j , i}^{k} & … & {a}_{j , N}^{k} \\ ⋮ & … & … & ⋱ & … & … & ⋮ \\ ⋮ & … & … & … & ⋱ & … & ⋮ \\ ⋮ & … & … & … & … & ⋱ & ⋮ \\ {a}_{N , 1}^{k} & … & {a}_{N , j}^{k} & … & {a}_{N , i}^{k} & … & {a}_{N , N}^{k}\end{matrix} ] ,$$

where α_{j,i} is any element in adjacency matrix A, j is a first number of the element α_{j,i}, and i is a second number of the element α_{j,i}, α_{j,i} indicates whether a j^{th} node x_{J} and an i^{th} node xᵢ in the graph G are connected with each other, and an element value is 1: α_{j,i}=1 when the j^{th} node xⱼ and the i^{th} node xᵢ are connected with each other, otherwise the element value is 0: α_{j,i}=0

$${a}_{j , i}^{k}$$

indicates whether the j^{th} node xⱼ and the i^{th} node xᵢ are connected with each other through at most k−1 intermediate nodes; when the j^{th} node xⱼ and the i^{th} node xᵢ are connected with each other through at most k−1 intermediate nodes, the element value is 1:

$${a}_{j , i}^{k} = 1 ,$$

and when

$${a}_{j , i}^{k} = 1 ,$$

the i^{th} node xᵢ is a k-hop neighbor node of the j^{th} node xⱼ, otherwise, the element value is 0:

$${a}_{j , i}^{k} = 0 ;$$

a j^{th} row in the k-order adjacency matrix A^{k} is a row where the node xⱼ is located, and j^{th} column in the k-order adjacency matrix A^{k} is a column where the node xⱼ is located; and the adjacency matrix A and k-order adjacency matrix A^{k} of the graph G are written into DDR4 storage outside FPGA; and a FIFO-cnt counter and six preprocessing units are provided.

(3.2) Selecting any six test nodes from the test set Tₑ, and allocating a corresponding preprocessing unit to any one test node, respectively; scanning, by each preprocessing unit, the row of the respective test node from the k-order adjacency matrix A^{k} of the graph G to obtain row data of the test nodes and to determine a number of k-hop neighbor nodes for the respective test node.

Sorting the obtained numbers of the k-hop neighbor nodes of the six test nodes in a descending order. A test node with a larger number of k-hop neighbor nodes is given priority in sub-step (3.3), and when the number of k-hop neighbor nodes is the same, a test node with a smaller serial number is given priority in sub-step (3.3).

(3.3) Setting eight segment traversal units, dividing evenly the row data obtained by scanning the test nodes into eight segments, distributing the eight segments to the eight segment traversal units in turn. Each segment traversal unit has a write initiation application and a write enable response; and controlling, by an arbiter, applications initiated by the eight segment traversal units for round-robin arbitration, traversing, by each segment traversal unit, the allocated row data, finding the test nodes corresponding to second numbers of all elements with an element value of 1 in the graph G as the k-hop neighbor nodes of the test nodes, to obtain the k-hop neighbor node set of the test nodes.

Intercepting the k-order adjacency matrix A^{k} of the graph G by the k-hop neighbor node set of the test nodes, including: intercepting the corresponding row data from the k-order adjacency matrix of the graph G according to the number of each k-hop neighbor node to obtain a row matrix of the test nodes; and intercepting the corresponding column data from the row matrix of the test nodes according to the number of each k-hop neighbor node to obtain the subgraph adjacency matrix of the test nodes.

(3.4) Performing the sub-step (3.3) on the six test nodes in turn to obtain the corresponding k-hop neighbor node set and the subgraph adjacency matrix, respectively.

(3.5) Then, selecting any six test nodes from the remaining test nodes in the test set Tₑ, repeating the sub-step (3.1) to the sub-step (3.4) until each test node in the test set Tₑ obtains the respective k-hop neighbor node set and the respective subgraph adjacency matrix, and obtaining a subgraph adjacency matrix set

$$\{ {A}_{sub}^{1} , {A}_{sub}^{2} , … , {A}_{sub}^{q} , … , {A}_{s u b}^{Q} \} ,$$

where

$${A}_{sub}^{q}$$

represents the subgraph adjacency matrix corresponding to the test node \tilde{x}_{q}.

For example, when the graph G is shown in FIG. 2, there are 7 nodes in the graph G, that is, the graph node set V: V={x₁,x₂,x₃,x₄,x₅,x₆,x₇}. The graph node set V is divided into a training set Tᵣ,={x̅₁,x̅₂,x̅₃,x̅₄,x̅₅}={x₁,x₂,x₃,x₄,x₅} and a test set Tₑ={\tilde{x}₁,\tilde{x}₂,\tilde{x}₃,\tilde{x}₄,\tilde{x}₅,\tilde{x}₆}={x₁,x₂,x₃,x₄,x₅,x₇}.

Taking the graph G shown in FIG. 2 as an example, in this embodiment, k=2, and the step (3) specifically includes the following sub-steps:

(3.1) The adjacency matrix A and k=2-order adjacency matrix A^{k=2} of the graph G are obtained.

(3.2) For any six test nodes in the test set Tₑ, a corresponding preprocessing unit is assigned to any one test node.

The first preprocessing unit scans the row of the test node z₁ from the k=2-order adjacency matrix A^{k=2} of the graph G to obtain the row data of the test node \tilde{x}₁:

$${A}_{{\tilde{x}}_{1}}^{k} = [ 1110011 ] ,$$

and obtain the number

$${N}_{1}^{k = 2} = 5$$

of k=2-hop neighbor nodes of the test node \tilde{x}₁; similarly, the second preprocessing unit obtains the number

$${N}_{2}^{k = 2} = 7$$

of k=2-hop neighbor nodes of the test node \tilde{x}₂; the third preprocessing unit obtains the number

$${N}_{3}^{k = 2} = 6$$

of k=2-hop neighbor nodes of the test node \tilde{x}₃; the fourth preprocessing unit obtains the number of k=2 hop neighbor nodes of the test node; the fifth preprocessing unit obtains the number

$${N}_{4}^{k = 2} = 4$$

of k=2-hop neighbor nodes of the test node \tilde{x}₆; the sixth preprocessing unit obtains the number

$${N}_{6}^{k = 2} = 4$$

of k=2 hop neighbor nodes of the test node \tilde{x}₆. Sorting is carried out in a descending order, and the order of step (3.3) is \tilde{x}₂, \tilde{x}₃, \tilde{x}₁, \tilde{x}₄, \tilde{x}₅, \tilde{x}₆.

(3.3) Eight segment traversal units are provided, and the row data obtained by scanning the test node \tilde{x}₂ are evenly divided into eight sections to be distributed to the eight segment traversal units in turn: the first segment traversal unit is allocated with

$$[ {a}_{2 , 1}^{k} ] = [ 1 ] ,$$

the second segment traversal unit is allocated with

$$[ {a}_{2 , 2}^{k} ] = [ 1 ] ,$$

the third segment traversal unit is allocated with

$$[ {a}_{3 , 2}^{k} ] = [ 1 ] ,$$

the fourth segment traversal unit is allocated with

$$[ {a}_{4 , 2}^{k} ] = [ 1 ] ,$$

the fifth segment traversal unit is allocated with

$$[ {a}_{5 , 2}^{k} ] = [ 1 ] ,$$

the sixth segment traversal unit is allocated with

$$[ {a}_{6 , 2}^{k} ] = [ 1 ] ,$$

the seventh segment traversal unit is allocated with

$$[ {a}_{7 , 2}^{k} ] = [ 1 ]$$

and the eighth segment traversal unit is allocated with [ ]=[ ]; each segment traversal unit has a write initiation application and a write enable response, and the applications initiated by the eight segment traversal units are controlled by an arbiter for round-robin arbitration, and each segment traversal unit traverses the allocated row data to find the nodes corresponding to the second numbers of all elements with an element value of 1 in the graph G as the k=2-hop neighbor nodes of the test node, so as to obtain the k=2-hop neighbor node set of the test node: {x₁, x₂, x₃,x₄, x₅,x₆,x₇.

The k-order adjacency matrix of the graph G is intercepted through the k-hop neighbor node set of the test node \tilde{x}₂: firstly, the corresponding row data is intercepted from the k=2-order adjacency matrix of the graph G according to the number of each k-hop neighbor node: the number of each k-hop neighbor node is 1, 2, 3, 4, 5, 6 and 7, respectively, that is, the first row, the second row, the third row, the fourth row, the fifth row, the sixth row and the seventh row are intercepted from the k=2-order adjacency matrix A^{k=2} of the graph G to obtain the row data

$${A}_{2}^{h}$$

of the test node \tilde{x}₂; then the corresponding column data is intercepted from the row matrix

$${A}_{2}^{h}$$

of the test node \tilde{x}₂ according to the number of each k-hop neighbor node to obtain the subgraph adjacency matrix

$${A}_{sub}^{2}$$

of the test node \tilde{x}₂:

$${A}_{sub}^{2} = [ \begin{matrix}{a}_{1 , 1}^{k} & {a}_{1 , 2}^{k} & {a}_{1 , 3}^{k} & {a}_{1 , 4}^{k} & {a}_{1 , 5}^{k} & {a}_{1 , 6}^{k} & {a}_{1 , 7}^{k} \\ {a}_{2 , 1}^{k} & {a}_{2 , 2}^{k} & {a}_{2 , 3}^{k} & {a}_{2 , 4}^{k} & {a}_{2 , 5}^{k} & {a}_{2 , 6}^{k} & {a}_{2 , 7}^{k} \\ {a}_{3 , 1}^{k} & {a}_{3 , 2}^{k} & {a}_{3 , 3}^{k} & {a}_{3 , 4}^{k} & {a}_{3 , 5}^{k} & {a}_{3 , 6}^{k} & {a}_{3 , 7}^{k} \\ {a}_{4 , 1}^{k} & {a}_{4 , 2}^{k} & {a}_{4 , 3}^{k} & {a}_{4 , 4}^{k} & {a}_{4 , 5}^{k} & {a}_{4 , 6}^{k} & {a}_{4 , 7}^{k} \\ {a}_{5 , 1}^{k} & {a}_{5 , 2}^{k} & {a}_{5 , 3}^{k} & {a}_{5 , 4}^{k} & {a}_{5 , 5}^{k} & {a}_{5 , 6}^{k} & {a}_{5 , 7}^{k} \\ {a}_{6 , 1}^{k} & {a}_{6 , 2}^{k} & {a}_{6 , 3}^{k} & {a}_{6 , 4}^{k} & {a}_{6 , 5}^{k} & {a}_{6 , 6}^{k} & {a}_{6 , 7}^{k} \\ {a}_{7 , 1}^{k} & {a}_{7 , 2}^{k} & {a}_{7 , 3}^{k} & {a}_{7 , 4}^{k} & {a}_{7 , 5}^{k} & {a}_{7 , 6}^{k} & {a}_{7 , 7}^{k}\end{matrix} ] = [ \begin{matrix}1 & 1 & 1 & 0 & 0 & 1 & 1 \\ 1 & 1 & 1 & 1 & 1 & 1 & 1 \\ 1 & 1 & 1 & 1 & 1 & 0 & 1 \\ 0 & 1 & 1 & 1 & 1 & 0 & 0 \\ 0 & 1 & 1 & 1 & 1 & 0 & 0 \\ 1 & 1 & 0 & 0 & 0 & 1 & 0 \\ 1 & 1 & 1 & 0 & 0 & 0 & 1\end{matrix} ] .$$

(3.4) The remaining five test nodes \tilde{x}₃, \tilde{x}₁, \tilde{x}₄, \tilde{x}₅, \tilde{x}₆ are subjected to step (3.3) in turn to obtain the corresponding k=2-hop neighbor node set and subgraph adjacency matrix respectively: the k=2-hop neighbor node set of the test node \tilde{x}₃ is {x₁,x₂,x₃,x₄,x₅,x₇} and the subgraph adjacency matrix

$${A}_{sub}^{3} ,$$

the k=2-hop neighbor node set of the test node \tilde{x}₁ is {x₁, x₂,x₃, x₆, x₇} and the subgraph adjacency matrix

$${A}_{sub}^{1} ,$$

the k=2-hop neighbor node set of the test node \tilde{x}₄ is {x₂,x₃,x₄,x₅} and the subgraph adjacency matrix

$${A}_{sub}^{4} ,$$

the k=2-hop neighbor node set of the test node \tilde{x}₅ is {x₂,x₃,x₄, x₅} and the subgraph adjacency matrix

$${A}_{sub}^{5} ,$$

and k=2-hop neighbor node set of the test node \tilde{x}₆ is {x₁,x₂,x₃,x₇} and the subgraph adjacency matrix

$${A}_{sub}^{6} .$$

(3.5) Because there are no remaining test nodes in the test set Tₑ, the subgraph adjacency matrix set

$$\{ {A}_{sub}^{1} , {A}_{sub}^{2} , {A}_{sub}^{3} , {A}_{sub}^{4} , {A}_{sub}^{5} , {A}_{sub}^{6} \}$$

is obtained.

(4) For each test node in the test set, the corresponding explanatory subgraph is obtained through the subgraph adjacency matrix corresponding to each test node.

The step (4) specifically includes the following sub-steps:

(4.1) When the number

$${N}_{q}^{k}$$

of k-hop neighbor nodes of any test node \tilde{x}_{q} in the test set is not more than m, performing a corresponding HN table operation on the subgraph adjacency matrix

$${A}_{sub}^{q}$$

of the test node \tilde{x}_{q}, including:

(c1) Acquiring a connectivity result set of all permutations and combinations of nodes in the k-hop neighbor node set of the test node \tilde{x}_{q} in FPGA hardware to obtain a matrix P_{q}.

For example, for the subgraph adjacency matrix

$${A}_{sub}^{q}$$

with the number

$${N}_{q}^{k}$$

of k-hop neighbor nodes being m=5,

The generation method of the matrix P is as follows:

Firstly, each element in the matrix P (m=5 node arrangement and combination) consists of m segments, where the composition of the l^{th} element is P{t}=[single-node result|double-node result|three-node result| . . . |m-node result].

The following can be obtained for the single-node result according to the meaning,

$$P ( 1 ) = [ 10000 \vert {0 … 0}_{m * ( m - 1 ) / 2 = 10} \vert {0 … 0}_{m * ( m - 1 ) * ( m - 2 ) / 6 = 10} \vert {0 … 0}_{m * ( m - 1 ) * ( m - 2 ) * ( m - 3 ) / 24 = 5} \vert {0}_{m * ( m - 1 ) * ( m - 2 ) * ( m - 3 ) * ( m - 4 ) / 120 = 1} ] ,$$

$$P ( 2 ) = [ 0 \; 1000 \vert 0 … 0 \vert 0 … 0 \vert 0 … 0 \vert 0 ] ,$$

$$P ( 3 ) = [ 0 \; 0100 \vert 0 … 0 \vert 0 … 0 \vert 0 … 0 \vert 0 ] ,$$

$$P ( 4 ) = [ 0 \; 0010 \vert 0 … 0 \vert 0 … 0 \vert 0 … 0 \vert 0 ] ,$$

$$P ( 5 ) = [ 00 \; 001 \vert 0 … 0 \vert 0 … 0 \vert 0 … 0 \vert 0 ] .$$

By reading the value between one node permutation and combination in the subgraph adjacency matrix

$${A}_{sub}^{q} ,$$

the double-node result can be obtained quickly, for example, P(6) corresponds to the connectivity result of the permutation and combination {\ddot{x}₁,\ddot{x}₂} of two nodes, where \ddot{x}₁ is the first node in the k-hop neighbor node set of the test node \tilde{x}_{q}, \ddot{x}₂ is the second node in the k-hop neighbor node set of the test node \tilde{x}_{q}. If A[\ddot{x}₁,\ddot{x}₂]==1, it means that the node \ddot{x}₁ and the node \ddot{x}₂ are connected in the subgraph adjacency matrix

$${A}_{sub}^{q} ,$$

then P(6)=[00000|10 . . . 0|0 . . . 0|0 . . . 0|0]|. If A[\ddot{x}₁,\ddot{x}₂]0, it means that the node \ddot{x}₁ and the node \ddot{x}₂ are not connected in the subgraph adjacency matrix

$${A}_{sub}^{q} ,$$

then P(6)=[11000|00 . . . 0|0 . . . 0|0 . . . 0|0]. The connectivity results of the other double-node permutation and combination are obtained by the same method.

The connectivity result of three-node permutation and combination is: P(16),P(17), . . . P(25), for example, P(16) corresponds to three-node permutation and combination{\ddot{x}₁,\ddot{x}₂,\ddot{x}₃}, which includes three two-node permutation and combinations: {\ddot{x}₁,\ddot{x}₂}, {\ddot{x}₁,\ddot{x}₃} and {\ddot{x}₂,\ddot{x}₃}. If the number of 1 in {A[\ddot{x}₁,\ddot{x}₂],A[\ddot{x}₁,\ddot{x}₃],A[\ddot{x}₂,\ddot{x}₃]} is greater than or equal to 2, then nodes \ddot{x}₁, \ddot{x}₂ and \ddot{x}₃ are connected in the subgraph adjacency matrix

$${A}_{sub}^{q} ,$$

thus P(16)=[00000|0 . . . 0|1 0 0 0 0|0 . . . 0|]. If the number of 1 in {A[\ddot{x}₁,\ddot{x}₂],A(\ddot{x}₁,\ddot{x}₃]}, is 0, the nodes \ddot{x}₁, \ddot{x}₂ and \ddot{x}₃ are not connected with each other in the subgraph adjacency matrix

$${A}_{sub}^{q} ,$$

thus P(16)=[11000|0 . . . 0|0 . . . 0|0 . . . 0|0]. If {A[\ddot{x}₁,\ddot{x}₂],A[\ddot{x}₁,\ddot{x}₃],A[\ddot{x}₂,\ddot{x}₃]}={0,0,1}, only the nodes \ddot{x}₂ and \ddot{x}₃ are connected with each other in the subgraph adjacency matrix

$${A}_{sub}^{q} ,$$

thus P(16)=[01000|0000100000|0 . . . 0|0 . . . 0|0]. If {A[\ddot{x}₁,\ddot{x}₂], A[\ddot{x}₁,\ddot{x}₃], A[\ddot{x}₂,\ddot{x}₃]}={0,1,0}, only the nodes \ddot{x}₁ and \ddot{x}₂ are connected with each other in the subgraph adjacency matrix

$${A}_{sub}^{q} ,$$

thus P(16)=[01000|01000000000|0 . . . 0|0 . . . 0|0]. If {A[\ddot{x}₁,\ddot{x}₂], A[\ddot{x}₁,\ddot{x}₃], A[\ddot{x}₂,\ddot{x}₃]}={1,0,0}, only the nodes \ddot{x}₁ and \ddot{x}₂ are connected with each other in the subgraph adjacency matrix

$${A}_{sub}^{q} ,$$

thus P(16)=[00100|10000000000|0 . . . 0|0 . . . |0].The connectivity results of the other three nodes are obtained by the same method.

The connectivity result of four-node permutation and combination is: P(26),P(27), . . . P(30) for example, P(26) corresponds to four-node permutation and combination {\ddot{x}₁,\ddot{x}₂,\ddot{x}₃,\ddot{x}₄}, which includes four three-node permutation and combinations: {x₁,x₂,x₃}, {x₁,x₂,x₄}, {x₁,x₃,x₄} and {x₂,x₃,x₄}. If the number of 1 in {A[\ddot{x}₁,\ddot{x}₂,\ddot{x}₃],A[\ddot{x}₁,\ddot{x}₂,\ddot{x}₄],A[\ddot{x}₁,\ddot{x}₃,\ddot{x}₄],A[\ddot{x}₂,\ddot{x}₃,\ddot{x}₄]} is greater than or equal to 2, then the nodes \ddot{x}₁, \ddot{x}₂, \ddot{x}₃ and \ddot{x}₄ are connected in the subgraph adjacency matrix

$${A}_{sub}^{q} ,$$

thus P(26)=[00000|0 . . . 0|0 . . . 0|10000|0]. If the number of 1 in (A[\ddot{x}₁,\ddot{x}₂,\ddot{x}₃],A[\ddot{x}₁,\ddot{x}₂,\ddot{x}₄],A[\ddot{x}₁,\ddot{x}₃,\ddot{x}₄],A[\ddot{x}₂,\ddot{x}₃,\ddot{x}₄} is 0, then the nodes \ddot{x}₁, \ddot{x}₂, \ddot{x}₃ and \ddot{x}₄ are not connected with each other in the subgraph adjacency matrix

$${A}_{sub}^{q} ,$$

thus P(26)=[11110|0 . . . 0|0 . . . 0|00000|0]. If {A[\ddot{x}₁,\ddot{x}₂,\ddot{x}₃],A[\ddot{x}₁,\ddot{x}₂,\ddot{x}₄],A[\ddot{x}₁,\ddot{x}₃,\ddot{x}₄],\ddot{x}₂,\ddot{x}₃,\ddot{x}₄]}={0001}, the nodes \ddot{x}₂, \ddot{x}₃ and \ddot{x}₄ are connected in the subgraph adjacency matrix

$${A}_{sub}^{q} ,$$

thus P(26)=[10000|0 . . . 0|00000010000|00000|0]. If {A[\ddot{x}₁,\ddot{x}₂,\ddot{x}₃],A[\ddot{x}₁,\ddot{x}₂,\ddot{x}₄],A[\ddot{x}₁,\ddot{x}₃,\ddot{x}₄],A[\ddot{x}₂,\ddot{x}₃,\ddot{x}₄]}={0010}, the nodes \ddot{x}₁, \ddot{x}₃ and \ddot{x}₄ are connected in the subgraph adjacency matrix

$${A}_{sub}^{q} ,$$

thus P(26)=[01000|0 . . . 0|0001000000|00000|0]. If {A[\ddot{x}₁,\ddot{x}₂,\ddot{x}₃],A[\ddot{x}₁,\ddot{x}₂,\ddot{x}₄],A[\ddot{x}₁,\ddot{x}₃,\ddot{x}₄],A[\ddot{x}₂,\ddot{x}₃,\ddot{x}₄]}={0100}, the nodes \ddot{x}₁, \ddot{x}₂ and \ddot{x}₄ are connected in the subgraph adjacency matrix

$${A}_{sub}^{q} ,$$

thus P(26)=[00100|0 . . . 0|0100000000|00000|0]. If {A[\ddot{x}₁,\ddot{x}₂,\ddot{x}₃],A[\ddot{x}₁,\ddot{x}₂,\ddot{x}₄],A[\ddot{x}₁,\ddot{x}₃,\ddot{x}₄],A[\ddot{x}_{2l, \ddot{x}}₃,\ddot{x}₄]}={1000}, the nodes \ddot{x}₁, \ddot{x}₂ and \ddot{x}₃ are connected in the subgraph adjacency matrix

$${A}_{sub}^{q} ,$$

thus P(26)=[00010|0 . . . 0|10000000000|00000|0]. The connectivity results of the other four nodes are obtained by the same method.

Subsequent m+1=5-node process also needs to count the number of corresponding m-node permutation and combination results 1 to get the corresponding P(31). If the number of 1 is greater than or equal to 2, it means that these m+1 nodes are connected, and the permutation position element in the corresponding P(31) is 1: P(31)=[00000|0 . . . 0|0 . . . 0|0 . . . 0|1], otherwise, the result of the rest being all zeros indicates that m nodes are not connected with each other, otherwise, the corresponding P(31): P(31)=[11111|0 . . . 0|0 . . . 0|0 . . . 0|0] is obtained according to the positions of 1.

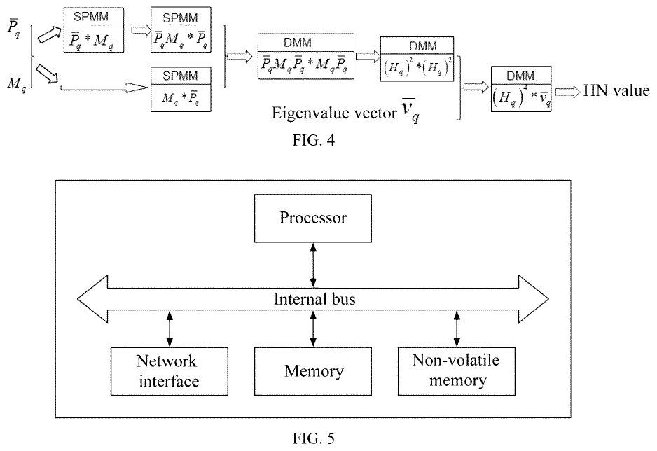

(c2) As shown in FIG. 4, (H_{q})⁴ is taken as the iterative convergence value of H_{q} to optimize the calculation of(H_{q})⁴, in which (H_{q})⁴ is divided into cubic sparse-dense matrix multiplication (SPMM) and quadratic dense matrix multiplication (DMM) by using the idempotent property of the matrix P̅_{q}, i.e., (P̅_{q})²=P̅_{q} and (H_{q})²=(P̅_{q}M_{q})P̅_{q}(M_{q}P̅_{q}). The sparse-dense matrix multiplication allocates tasks to elements with an element value of 1 in the sparse matrix, and the direct static mapping from matrix rows to eight PEs is adopted to increase the parallel calculation of hardware. There is a gap between the rows allocated by each PE, and the element with the element value of 1 in the middle of the row is searched in a round-robin manner to prevent the sparse matrix from gathering in some rows and the rows of data to be processed are effectively connected.

(c3)Eigenvalue results of all possible node combinations are pre-calculated according to the numbers of the nodes in the subgraph adjacency matrix of the test node \tilde{x}_{q}, and the eigenvalue results are spliced into an eigenvalue vector v̅_{q} according to an arrangement combination of single node, double nodes, . . . , m nodes.

The eigenvalue result of any node combination arrangement o is calculated by the following formula:

$$\overline{v} = [ f ( {G}_{sub}^{q} ) ] {\_y}_{q}^{*} \_o - {f\_y}_{q}^{*}$$

where

$$[ f ( {G}_{sub}^{q} ) ] {\_y}_{q}^{*} \_o$$

represents a probability average that all nodes in the node combination arrangement o are predicted to be

$${y}_{q}^{*} ; and {f\_y}_{q}^{*}$$

represents a probability average that all nodes in the graph G are predicted to be

$${y}_{q}^{*} .$$

An HN value matrix vector \tilde{v}_{q}:\tilde{v}_{q}=(H_{q})⁴*\tilde{v}_{q} is obtained, the first

$${N}_{q}^{k}$$

values in the HN value matrix vector \tilde{v}_{q} are taken as HN values of

$${N}_{q}^{k}$$

nodes in the k-hop neighbor node set of the test node \tilde{x}_{q}, respectively, to obtain an HN table of the subgraph adjacency matrix

$${A}_{sub}^{q}$$

of the test node \tilde{x}_{q}, namely an explanatory subgraph of the test node \tilde{x}_{q}.

(4.2) When the number

$${N}_{q}^{k}$$

of k-hop neighbor nodes of any test node \tilde{x}_{q} in the test set is greater than m, the subgraph adjacency matrix

$${A}_{sub}^{q}$$

of the test node \tilde{x}_{q} is sampled layer by layer on FPGA based on a central node to obtain a sampling graph adjacency matrix set

$$\{ {A}_{MC \_ 1}^{q} , {A}_{MC \_ 2}^{q} , ⋯ , {A}_{MC \_ {N}_{q}^{k}}^{q} \}$$

of the test node \tilde{x}_{q}.

Then, a corresponding HN table operation is carried out for each sampling diagram adjacency matrix

$$\{ {A}_{MC \_ 1}^{q} , {A}_{MC \_ 2}^{q} , ⋯ , {A}_{MC \_ {N}_{q}^{k}}^{q} \}$$

in the sampling diagram adjacency matrix set to obtain the HN table corresponding to each sampling diagram adjacency matrix; the HN value of each node in the subgraph adjacency matrix

$${A}_{sub}^{q}$$

of the test node \tilde{x}_{q} is tan average of HN values in different sampling graph adjacency matrices, and the explanatory subgraph of the test node \tilde{x}_{q} is obtained.

The sub-step (4.2) specifically includes the following sub-steps:

(4.2.1) When the number

$${N}_{q}^{k}$$

of the k-hop neighbor nodes of the test node \tilde{x}_{q} is greater than m, for the subgraph adjacency matrix

$${A}_{sub}^{q}$$

of the test node \tilde{x}_{q}, traversing shortest path of the subgraph adjacency matrix

$${A}_{sub}^{q}$$

of the test node \tilde{x}_{q} by taking the test node \tilde{x}_{q} as a target node.

In step (4.2.1), the test node \tilde{x}₂ in the test set Tₑ is taken as an example, specifically:

(a1) In this embodiment, m=5; the number of k=2-hop neighbor nodes of the test node \tilde{x}₂ is 7, that is, greater than m.

The number of the test node \tilde{x}₂ in the graph node set V is q′=2; the subgraph adjacency matrix for the test node \tilde{x}₂ is

$${A}_{sub}^{2} .$$

(a1) Firstly, traversal initialization is performed: an initialized node on an FPGA is a list with all zero element values being 0 and a length of

$${N}_{2}^{k = 2} = 7 : node = [ 0 , 0 , 0 , 0 , 0 , 0 , 0 ] ;$$

an initialized flag is a queue containing only the number of the target node in the graph node set V: flag=[flag(1)]=[2], which is used to store the neighbor node numbers obtained by BFS after each node traversal; an initialized node_flag is a list with an element value of 1 for a q^{th} element and element values of 0 for other elements as well as a length of

$${N}_{q}^{k} : node\_flag = [ 0 , 1 , 0 , 0 , 0 , 0 , 0 ] ,$$

this embodiment is aimed at the test node x₂, that is q=2, and the element value of the second element in the list node_flag is 1, that is node_flag(2)=1; an initialized node_f is a list with all element values being −1 and a length of

$${N}_{2}^{k = 2} = 7 :$$

node_f=−1,−1,−1,−1,−1,−1,−1]; an initialized bfs_cnt=1 is to control a subscript address of the queue flag for each access; an initialized node_pate is a list containing

$${N}_{q}^{k}$$

sub-lists:

$$node\_pate = [ node\_pate [ 1 ] , … , node\_pate [ E ] , … , node\_pate [ {N}_{q}^{k} ] ] ,$$

where node_pate [E] is an E^{th} sub-list in the list node_pate, and each sub-list respectively contains

$${N}_{q}^{k}$$

elements with all element values being 0.

(a2) After traversal initialization, access is carried out according to the value of bfs_cnt to obtain the element value of a first element in the listflag:flag(bfs_cnt=1)=2; then the list node is updated: the element value of a flag(bfs_cnt=1)=2^{nd} element in the list node is assigned with 1, and a node x_{flag(bfs_cnt=1)=2}=x₂ is taken as a current traversal target node, and the updated list node is node=[0,1,0,0,0,0,0], at this time, it is determined the element value of theflag(bfs_cnt=1)=2^{nd} element in a list node_f is −1, which means that the predecessor node of the current traversal target node x₂ is invalid, and then a second row of the subgraph adjacency matrix

$${A}_{s u b}^{q}$$

is read to obtain row data[1 1 1 0 0 0 1], and skip to step (a3) to update limited node information.

(a3) The read row data are traversed for effective elements: the row data is read to obtain the second number of the element with the first element value of 1 as 1. Since the second number 1 is different from the element value of 2 in the list flag, the list flag is updated: the second number 1 is added to the listflag, and after updating,flag=[2,1], and the list node_flag is updated: the element value of the first element in the list node_flag is assigned with 1. After the updating, node_flag=[1,1,0,0,0,0,0], and the predecessor node of the node x₁ is recorded as the current traversal target node x₂ and the list node_f is updated: the element value of one element in the list node_fl is assigned with the number M=2 of the current traversal target node; after updating: node_f[2,−1,−1,−1,−1,−1,−1], and then the row data is read to obtain the second number of the next element with an element value of 1 as 2: since the second number 2 is the same as the element value 2 in the listflag, the row data is read to obtain the second number of the next element with an element value of 1 as 3: since the second number 3 is different from the element value 2 in the list flag, the list flag is updated as flag=[2,1]; after updating, flag=[2,1,3], and the list node_fag is updated: node_flag=[1,1,1,0,0,0,0], and the predecessor node of the node x₃ is recorded as the current traversal target node x₂ and the list node_f is updated, after updating: node_f=[2,−1,2,−1,−1,−1,−1]; then, the row data is read to obtain the second number of the next element with an element value of 1 as 7: since the second number 7 is different from the element value of 2 in the list flag, the list flag=[2,1,3] is updated, after updating: flag=[2,1,3,7], and the list node_fag is updated, after updating: nodeflag=[1,1,1,0,0,0,1], and the predecessor node of the node x₇ is recorded as the current traversal target node x₂ and the list node_f is updated, after updating: node_f=[2,−1,2,−1,−1,−1,2]; at this time, the element with the element value of 1 cannot be read from the row data, and the traversal is ended; after the traversal, the value of bfs_cnt is updated: bfs_cnt=bfs_cnt+1=1+1=2.

Step (a2) is repeated according to the value of the updated bfs_cnt, including: access is carried out according to the value of bfs_cnt=2 to obtain the element value of a second element in the list flag: flag(bfs_cnt=2)=1; then the list node is updated: the element value of flag(bfs_cnt=2)=1^{st} element in the list node is assigned with 1, and a node x_{flag(bfs_cnt=2)=1}=x₁ is taken as a current traversal target node, and after updating: node=[1,1,0,0,0,0,0]; and at this time, it is determined that the element value of the lag(bfs_cnt=2)=1^{st} element in a list node_f is 2, which means that the current traversal target node x₁ is valid, and the list node_pate is updated: the path information from the current traversal target node to the target node is registered in the list node_pate, and the path information from the current traversal target node x₁ to the target node x₂ is the node x₁→ the node x₂, that is, the element value of the second element in the first sub-list in the list node_pate is registered as 1, and the updated list node_pate is node_pate=[[0 100000], [0000000], [0000000], [0000000], [0000000], [0 0 0 0 0 0 0], [0 0 0 0 0 0 0]]; then the first row of the subgraph adjacency matrix

$${A}_{s u b}^{q}$$

is read to obtain row data [1 1 1 0 0 1 1], and the read row data is traversed for effective elements; after the traversal, the node x₆ is obtained, the updated list flag is flag=[2,1,3,7,6], the updated list node_fag is node_fag=[1,1,1,0,0,1,1], and the predecessor node of the node x₆ is recorded as the current traversal target node x₁, the updated list node_f is node_f=[2,−1,2,−1,−1,1,2], and the value of the updated bfs_cnt is 3.

Step (a2) is repeated according to the value of the updated bfs_cnt, specifically as follows: according to the updated bfs_cnt=3, access is carried out to obtain the element value of the third element in the list flag:flag (3)=3; then the list node is updated, and the node x₃ is taken as the traversal target node; after the update: node=[1,1,1,0,0,0,0]; at this time, it is determined that the element value of the third element in the list node_f is 2, which indicates that the current traversal target node x₃ is valid, and the list node_pate is updated: the path information from the current traversal target node to the target node is registered in the list node_pate, and the path information from the current traversal target node x₃ to the target node x₂ is the node x₃→ the node x₂, that is, the element value of the second element in the three sub-lists in the list node_pate is registered as 1; then the third row of the subgraph adjacency matrix

$${A}_{sub}^{q}$$

is read to obtain row data [1 1 1 1 1 0 1], and the read row data is traversed for effective elements; after the traversal, nodes x₄ and x₅ are obtained, the updated list flag is flag=[2,1,3,7,6,4,5], and the updated list node_flag is node_flag=[1,1,1,1,1,1,1], and the predecessor node of node x₄ is recorded as the current traversal target node x₃ and the predecessor node of the node x₅ as the current traversal target node x₃, the updated list node_f is: node_f=[2,−1,2,3,3,1,2], and the value of the updated bfs_cnt is 4.

Step (a2) is repeated according to the value of the updated bfs_cnt, specifically as follows: according to the updated bfs_cnt=4, access is carried out to obtain the element value of the fourth element in the listflag:flag(4)=7; then the list node is updated, and the node x₇ is taken as the traversal target node; after the update: node=[1,1,1,0,0,0,1]; at this time, it is determined that the element value of the seventh element in the list node_f is 2, which indicates that the current traversal target node x₇ is valid, and the list node_pate is updated: the path information from the current traversal target node to the target node is registered in the list node_pate, and the path information from the current traversal target node x₇ to the target node x₂ is the node x₇→ the node x₂, that is, the element value of the second element in the seventh sub-list in the list node_pate is registered as 1; then, the seventh row of the subgraph adjacency matrix

$${A}_{s u b}^{q}$$

is read, and the read row data is traversed for effective elements; after the traversal, no nodes are obtained in this traversal, and the list flag, list node_fag and list node_f are not updated; the value of the updated bfs_cnt is 5.

Step (a2) is repeated according to the value of the updated bfs_cnt, specifically as follows: according to the updated bfs_cnt=5, access is carried out to obtain the element value of the fifth element in the list flag: flag(5)=6; then the list node is updated, and the node x₆ is taken as the traversal target node; after the update: node=[1,1,1,0,0,1,1]; at this time, it is determined that the element value of the sixth element in the list node_f is 1, which indicates that the current traversal target node x₆ is valid, and the list node_pate is updated: the path information from the current traversal target node to the target node is registered in the list node_pate, and the path information from the current traversal target node x₆ to the target node x₂ is the node x₆→the node x₁→the node x₂, that is, the element value of the first element in the sixth sub-list and the second element in the sixth sub-list in the list node_pate is registered as 1; then, the sixth row of the subgraph adjacency matrix

$${A}_{s u b}^{q}$$

is read, and the read row data is traversed for effective elements; after the traversal, no nodes are obtained in this traversal, and the listflag, list node_flag and list node_f are not updated; the value of the updated bfs_cnt is 6.

Step (a2) is repeated according to the value of the updated bfs_cnt, specifically as follows: according to the updated bfs_cnt=6, access is carried out to obtain the element value of the sixth element in the list flag:flag(6)=4; then the list node is updated, and the node x₄ is taken as the traversal target node; after the update: node=[1,1,1,1,0,1,1]; at this time, it is determined that the element value of the fourth element in the list node_f is 3, which indicates that the current traversal target node x₄ is valid, and the list node_pate is updated: the path information from the current traversal target node to the target node is registered in the list node_pate, and the path information from the current traversal target node x₄ to the target node x₂ is the node x₄→the node x₃→ the node x₂, that is, the element value of the third element in the fourth sub-list and the second element in the fourth sub-list in the list node_pate is registered as 1; then, the fourth row of the subgraph adjacency matrix

$${A}_{s u b}^{q}$$

is read, and the read row data is traversed for effective elements; after the traversal, no nodes are obtained in this traversal, and the listflag, list node_fag and list node_f are not updated; the value of the updated bfs_cnt is 7.

Step (a2) is repeated according to the value of the updated bfs_cnt, specifically as follows: according to the updated bfs_cnt=7, access is carried out to obtain the element value of the seventh element in the listflag:flag(7)=5; then the list node is updated, and the node x₅ is taken as the traversal target node; after the update: node=[1,1,1,1,1,1,1]; at this time, it is determined that the element value of the fifth element in the list node_f is 3, which indicates that the current traversal target node x₅ is valid, and the list node_pate is updated: the path information from the current traversal target node to the target node is registered in the list node_pate, and the path information from the current traversal target node x₅ to the target node x₂ is the node x₅→ the node x₃→ the node x₂, that is, the element value of the third element in the fifth sub-list and the second element in the fifth sub-list in the list node_pate is registered as 1; then, the fifth row of the subgraph adjacency matrix

$${A}_{s u b}^{q}$$

is read, and the read row data is traversed for effective elements; after the traversal, no nodes are obtained in this traversal, and the listflag, list node_flag and list node_f are not updated; the value of the updated bfs_cnt is 8.

Because the updated bfs_cnt value is

$${N}_{2}^{k} = 7 + 1 ,$$

it jumps to the idle state, and completes the shortest path traversal of the subgraph adjacency matrix

$${A}_{s u b}^{q = 2}$$

of the test node x₂, obtaining the updated list node_pate: node_pate=[[0 1 0 0 0 0 0], [0 0 0 0 0 0 0], [0 1 0 0 0 0 0], [0 11 0 0 0 0], [0 11 0 0 0 0], [11 0 0 0 0 0], [0 1 0 0 0 0 0]].

(4.2.2) While traversing the shortest path of the subgraph adjacency matrix

$${A}_{s u b}^{q}$$

of the test node \tilde{x}_{q}, the sampling graph node set is synchronously generated to obtain the sampling graph adjacency matrix set

$$\{ {A}_{MC \_ 1}^{q} , {A}_{MC \_ 2}^{q} , … , {A}_{MC \_ {N}_{q}^{k}}^{q} \}$$

of the test node q.

The substep (4.2.2) specifically includes the following sub-steps:

(b1) First, sample initialization: an initialized node_out is a list containing

$${N}_{q = 2}^{k} = 7$$

sub-lists, and each sub-list contains m=5, respectively, and all element values are null; an initialized node_y is a list with all element values being 0 and a length of

$${N}_{q}^{k} : {node}_{-} y = [ 0 , 0 , 0 , 0 , 0 , 0 , 0 ] ,$$

where node_y(c) is the element value of the c^{th} element in the list node_y.

(b2) After sampling initialization, the number of elements in the list flag is detected at any time: when it is detected that the number of elements in the list flag is m=5, a set of m nodes closest to the test node \tilde{x}_{q} is obtained: {x₂,x₁,x₃,x₇,x₆}, and skip to step (b3).

(b3) The list node_out is updated, and the updated list node_out is node_out=[[x₂,x₁, x₃, x₇, x₆], [x₂,x₁, x₃, x₇, x₆], [x₂,x₁, x₃, x₇, x₆], [x₂,x₁, x₃, x₇, x₆], [x₂,x₁, x₃, x₇, x₆], [x₂,x₁, x₃, x₇, x₆], [x₂,x₁, x₃, x₇, x₆]].

(b4) The updated value of bfs_cnt is updated at any time after the traversal: when the updated value of node_out is m+1=5+1=6, it means that m=5 nodes have been traversed in the traversal process of the shortest path, and skip to step (b5).

(b5) The list node_y is updated: each element value in the updated list node at this time after traversing is covered with each element value in the list node_y, and the updated list node_y is node_y=[1,1,1,0,0,1,1].

(b6) After traversing the shortest path of the subgraph adjacency matrix

$${A}_{s u b}^{q = 2}$$

of the test node \tilde{x}₂, the updated list node_pate is processed: the element value of the D^{th} element in the D^{th} subgraph of the list node_pate is assigned with 1, and the above operations are performed for each subgraph, and the obtained processed list node_pate is node_pate=[[1 1 00000], [0 1 00000], [0 1 1 0000], [01 1 1000], [0 1 10 1 00], [1 1 000 1 0], [0 1 0 0 0 0 1]].

The number of the element whose element value is 0 in the list node_y is obtained:

$${u}_{1} = 4 and {u}_{2} = 5 {u}_{2} = 5.$$

The number of u₁=4 is processed, the number of elements with an element value of 1 in the u₁=4^{th} row in the list node_pate is calculated as num_u₁=3, and a samplable node set node_pate{u₁=4}′ of the node xᵤ_{₁}₌₄ outside the shortest path node and closest to the test node \tilde{x}_{q=2} is obtained as node_pate{u₁=4}′=[1,0,0,0,0,1,1] through combinatorial logic (node_pate{u₁=4}& node_y)∧node_y; the element value of m-num_u₁=5−3=2 elements are arbitrarily retained as 1 from the samplable node set node_pate{u₁=4}′ of the node xᵤ_{₁}₌₄, and the element value of the rest is covered with 0 from 1 to obtain the second samplable node set node_pate{u₁=4} of the node xᵤ_{₁}₌₄ as node_pate{u₁=4}=[1,0,0,0,0,1,0]; an OR operation is carried out on node_pate{u₁=4}′=[1,0,0,0,0,1,1] and node_pate{u₁=4} to obtain the sampling node set of the node xᵤ_{₁}₌₄: node_pate{u₁=4}″: node_pate{u₁=4}″=[1,1,1,0,1,0]; the list node_out is updated: the number corresponding to each element with an element value of 1 in the sampling node set node_pate{u₁=4}″ of the node xᵤ_{₁}₌₄ is covered with the number of each element in the u₁=4^{th} row of the list node_out, and the updated list node_out is node_out=[[x₂,x₁, x₃, x₇, x₆], [x₂,x₁, x₃, x₇, x₆], [x₂,x₁, x₃, x₇, x₆], [x₁,x₂, x₃, x₄, x₆], [x₂,x₁, x₃, x₇, x₆], [x₂,x₁, x₃, x₇, x₆], [x₂,x₁, x₃, x₇, x₆]].

Then, the number u₂=5 is processed, and the number of elements with the element value of 1 in the u₂=5^{th} row in the list node_pate is calculated as num_u₂=3, and a samplable node set node_pate{u₂=5}′ of the node xᵤ_{₂}₌₅ outside the shortest path node and closest to the test node \tilde{x}_{q=2} is obtained as node_pate {u₂=5}′=[1,0,0,0,0,1,1] through combinatorial logic (node_pate{u₂=5}& node_y)∧node_y; the element value of m-num_u₂=5−3=2 elements are arbitrarily retained as 1 from the samplable node set node_pate {u₂=5}′ of the node xᵤ_{₂}₌₅, and the element value of the rest is covered with 0 from 1 to obtain the second samplable node set node_pate{u₂=5}″ of the node xᵤ_{₂}₌₅ as node_pate{u₂=5}″=[1,0,0,0,0,1,0]; an OR operation is carried out on node_pate{u₂=5}″=[1,0,0,0,0,1,1] and node_pate{u₂=5} to obtain the sampling node set of the node xᵤ_{₂}₌₅: node_pate{u₂=5}″: node_pate {u₂=5}″=[1,1,1,0,1,1,0].

The list node_out is updated: the number corresponding to each element with a value of 1 in the sampling node set node_pate {u₂=5}″ of the node xᵤ_{₂}₌₅ is sequentially covered with the number of each element in the u₂=5^{th} row of the list node_out, and the updated list node_out is node_out=[[x₂,x₁, x₃, x₇, x₆], [x₂,x₁, x₃, x₇, x₆], [x₂,x₁, x₃, x₇, x₆], [x₁,x₂, x₃, x₄, x₆], [x₁,x₂, x₃, x₅, x₆], [x₂,x₁, x₃, x₇, x₆], [x₂,x₁, x₃, x₇, x₆]], i.e., the sampled list node_out.

(b7) An adjacency matrix interception operation is carried out on the subgraph adjacency matrix

$${A}_{s u b}^{q}$$

of the test node \tilde{x}₂ by taking each row of data in the sampled list node_out as the sampling neighbor node set of the test node \tilde{x}₂ to obtain

$${N}_{2}^{k = 2} = 7$$

sampling graph adjacency matrices, that is, the sampling graph adjacency matrix set

$$\{ {A}_{MC \_ 1}^{q} , 1 {A}_{MC \_ 2}^{q} , … , {A}_{{MC \_ N}_{q}^{k}}^{q} \}$$

of the test node z_{q} is obtained.

(4.2.3) Then, the corresponding HN table operation is performed for each sampling diagram adjacency matrix in the sampling diagram adjacency matrix set to obtain the HN table corresponding to each sampling diagram adjacency matrix; the HN value of each node in the subgraph adjacency matrix

$${A}_{s u b}^{q}$$

of the test node is an average of HN values in different sampling graph adjacency matrices, and the explanatory subgraph of the test node \tilde{x}_{q} is obtained.

(4.3) Repeating step (4.1) or step (4.2) for each test node according to the number of k-hop neighbor nodes of each test node in the test set, so as to obtain an explanatory subgraph corresponding to each test node in the test set.

(4.3) Repeating step (4.1) or step (4.2) for each test node according to the number of k-hop neighbor nodes of each test node in the test set, so as to obtain the explanatory subgraph corresponding to each test node in the test set.

In some embodiments, the explanatory subgraph obtained in step (4) may be further configured to generate machine-readable explanatory output data. The explanatory output data includes a key node identifier set and/or a key edge identifier set corresponding to the explanatory subgraph, and may further include a mask representation or an index representation for indicating the key nodes and/or the key edges. The explanatory output data may be output or transmitted via an interface to an external application module, so as to trigger at least one of alarm processing, visualization presentation, and/or policy generation performed by the external application module.

Embodiment 2: corresponding to the aforementioned Embodiment 1 of a method for interpreting the graph neural network based on FPGA acceleration, the present disclosure further provides an embodiment of a graph neural network interpretation device based on FPGA acceleration.

Referring to FIG. 5, a graph neural network interpretation device based on FPGA acceleration provided by an embodiment of the present disclosure includes one or more processors for implementing the method for interpreting the graph neural network based on FPGA acceleration in the above embodiment.

The embodiment of the graph neural network interpretation device based on FPGA acceleration of the present disclosure can be applied to any device with data processing capability, which can be devices or devices such as computers. The embodiment of the device can be realized by software, or by hardware or a combination of hardware and software. Taking software implementation as an example, as a logical device, it is formed by reading the corresponding computer program instructions in the non-volatile memory into the memory through the processor of any equipment with data processing capability. From the hardware level, as shown in FIG. 5, it is a hardware structure diagram of any device with data processing capability where the graph neural network interpretation device based on FPGA acceleration of the present disclosure is located. In addition to the processor, memory, network interface and nonvolatile memory shown in FIG. 5, any device with data processing capability in the embodiment usually includes other hardware according to the actual function of the device with data processing capability, which will not be described here. In some embodiments, the device includes an interface module for external communication (e.g., a network interface). The interface module is configured to output or transmit the machine-readable explanation output data generated based on the explanation subgraph to an external application module, and the external application module is configured to perform at least one of alarm processing, visualization presentation, and/or policy generation based on the explanation output data.

The implementing process of the functions and functions of each unit in the above-mentioned device is detailed in the implementing process of the corresponding steps in the above-mentioned method, and will not be repeated here.

For the device embodiment, because it basically corresponds to the method embodiment, it is only necessary to refer to part of the description of the method embodiment for the relevant points. The device embodiments described above are only schematic, in which the units described as separate components may or may not be physically separated, and the components displayed as units may or may not be physical units, that is, they may be located in one place or distributed to multiple network units. Some or all of the modules can be selected according to actual needs to achieve the purpose of the solution of the present disclosure. Those skilled in the art can understand and implement it without creative labor.

The embodiment of the present disclosure also provides a non-transitory computer-readable storage medium, on which a program is stored, and when the program is executed by a processor, the method for interpreting the graph neural network based on FPGA acceleration in the above embodiment is realized. The non-transitory computer-readable storage medium can be an internal storage unit of any device with data processing capability as described in any of the previous embodiments, such as a hard disk or a memory. The non-transitory computer-readable storage medium can also be an external storage device of any device with data processing capability, such as a plug-in hard disk, Smart Media Card (SMC), SD card, Flash Card, etc. provided on the device. Further, the non-transitory computer-readable storage medium can also include both internal storage units and external storage devices of any device with data processing capability. The non-transitory computer-readable storage medium is used for storing the computer program and other programs and data required by any equipment with data processing capability, and can also be used for temporarily storing data that has been output or will be output.

The above is only the preferred embodiment of the present disclosure, and it is not used to limit the present disclosure. Any modification, equivalent substitution, improvement and the like made within the spirit and principle of the present disclosure shall be included in the scope of protection of the present disclosure.

What is claimed is:

1. A method for interpreting a graph neural network based on FPGA acceleration, comprising the following steps:
step (1) acquiring a target data set; and dividing the target data set into a training set and a test set;
step (2) training the graph neural network using the training set to obtain a trained graph neural network; and classifying each test node in the test set using the trained graph neural network to obtain a test prediction label set;
step (3) obtaining a k-hop neighbor node set and a subgraph adjacency matrix corresponding to each test node in the test set on Field-Programmable Gate Array (FPGA); and
step (4) generating an explanatory subgraph through the subgraph adjacency matrix corresponding to each test node in the test set, and displaying, by the explanatory subgraph, test nodes of the graph neural network and connection relationships between the test nodes to quickly and accurately reveal decision-making basis of the graph neural network in node classification and prediction.

2. The method for interpreting the graph neural network based on FPGA acceleration according to claim 1, wherein the step (1) further comprises: acquiring data of a node classification task scene, and constructing into a graph G corresponding to the data, wherein the graph G has a total of N nodes, that is, a graph node set V={x₁,x₂, . . . ,xₙ, . . . ,x_{N}}, where xₙ represents a n^{th} node; dividing the graph node set V into the training set Tᵣ=(x̅₁, x̅₂, . . . ,x̅ₚ, . . . ,x̅_{P}} and the test set Tₑ={(\tilde{x}₁,\tilde{x}₂, . . . , \tilde{x}_{q} . . . ,\tilde{x}_{Q}}, wherein the training set Tᵣ has a total of P nodes, and x̅ₚ is any node in the training set Tᵣ, and the test set Tₑ has a total of Q nodes, and \tilde{x}_{q} is any node in the test set Tₑ; and obtaining a real label set Yᵣ={y̅₁,y̅₂, . . . ,y̅ₚ, . . . ,y̅_{P}} corresponding to the training set Tᵣ, where y̅ₚ represents areal label of the node x̅ₚ.

3. The method for interpreting the graph neural network based on FPGA acceleration according to claim 2, wherein the step (2) further comprises the following sub-steps:
sub-step (2.1) a neighbor node set of any node x̅ₚ in the training set Tᵣ in the graph G being N(x̅ₚ),receiving, by the node x̅ₚ, a message
$${m}_{u}^{l} = M S G ( {h}_{u}^{l - 1} )$$
propagated by each node
$${\overline{x}}_{u}^{p}$$
in the neighbor node set N(x̅ₚ) in each layer of the graph neural network, where
$${\overline{x}}_{u}^{p} ∈ N ( p ) ,$$
l represents a l^{th} layer of the graph neural network, l=1, 2, . . . ,l, . . . ,L,
$${h}_{u , p}^{l - 1}$$
represents a feature representation of the node
$${\overline{x}}_{u}^{p}$$
a l−1^{th} layer, and
$${h}_{u , p}^{0} = {X}_{u , p}$$
represents an initial feature representation of the node
$${\overline{x}}_{u}^{p} ;$$
sub-step (2.2) calculating an aggregated message
$${M}_{p}^{l}$$
of the node x̅ₚ at each layer as follows:
$${M}_{p}^{l} = {AGG}_{{\overline{x}}_{u} ∈ N ( p )} ( {m}_{u}^{l} ) ,$$
where AGG(.) represents an aggregate function;
sub-step (2.3) performing, by the graph neural network, nonlinear transformation on the aggregated message
$${M}_{p}^{l}$$
and a feature representation
$${h}_{p}^{l - 1}$$
of the node x̅ₚ at an upper layer to obtain a feature representation
$${h}_{p}^{l}$$
of the node x̅ₚ at the l^{th} layer, and calculating the feature representation
$${h}_{p}^{l}$$
as follows:
$${h}_{p}^{l} = Updata ( {M}_{p}^{l} , {h}_{p}^{l - 1} ) ,$$
where Update(.) represents an update function; and
obtaining a final embedding of the node x̅ₚ in the graph neural network by
$${z}_{p} = {h}_{p}^{L} ;$$
sub-step (2.4) repeating the sub-step (2.1) to the sub-step (2.3) for each node in the training set Tᵣ, to obtain a final embedding set Zᵣ: Zᵣ={z₁,z₂, . . . , zₚ, . . . , z_{P}};
sub-step (2.5) classifying each test node using a fully connected layer according to the final embedding set Zᵣ, and training and optimizing the graph neural network using across entropy loss function, to obtain the trained graph neural network
$$f ( \cdot ) = V {⟶}^{A , X} Y ;$$
and
sub-step (2.6) classifying each node in the test set Tₑ using the trained graph neural network to obtain the test prediction label set
$${Y}_{e} = \{ {y}_{1}^{*} , {y}_{2}^{*} , … , {y}_{q}^{*} , … , {y}_{Q}^{*} \} ,$$
where
$${y}_{q}^{*}$$
represents a prediction label of any test node \tilde{x}_{q} in the test set Tₑ, and calculating
$${y}_{q}^{*}$$
as follows:
$${y}_{q}^{*} = arg max [ f ( {\tilde{x}}_{q} ) ] .$$

4. The method for interpreting the graph neural network based on FPGA acceleration according to claim 3, wherein the step (3) further comprises the following sub-steps:
sub-step (3.1) acquiring an adjacency matrix A and a k-order adjacency matrix A^{k} of the graph G, wherein A and A^{k} are represented as follows:
$$A = [ \begin{matrix}{a}_{1 , 1} & ⋯ & ⋯ & ⋯ & {a}_{1 , i} & ⋯ & {a}_{1 , N} \\ ⋮ & ⋱ & ⋯ & ⋯ & ⋯ & ⋯ & ⋮ \\ {a}_{j , 1} & ⋯ & {a}_{j , j} & ⋯ & {a}_{j , i} & ⋯ & {a}_{j , N} \\ ⋮ & ⋯ & ⋯ & ⋱ & ⋯ & ⋯ & ⋮ \\ ⋮ & ⋯ & ⋯ & ⋯ & ⋱ & ⋯ & ⋮ \\ ⋮ & ⋯ & ⋯ & ⋯ & ⋯ & ⋱ & ⋮ \\ {a}_{N , 1} & ⋯ & {a}_{N , j} & ⋯ & {a}_{N , i} & ⋯ & {a}_{N , N}\end{matrix} ] , and$$
$${A}^{k} = [ \begin{matrix}{a}_{1 , 1}^{k} & ⋯ & ⋯ & ⋯ & {a}_{1 , i}^{k} & ⋯ & {a}_{1 , N}^{k} \\ ⋮ & ⋱ & ⋯ & ⋯ & ⋯ & ⋯ & ⋮ \\ {a}_{j , 1}^{k} & ⋯ & {a}_{j , j}^{k} & ⋯ & {a}_{j , i}^{k} & ⋯ & {a}_{j , N}^{k} \\ ⋮ & ⋯ & ⋯ & ⋱ & ⋯ & ⋯ & ⋮ \\ ⋮ & ⋯ & ⋯ & ⋯ & ⋱ & ⋯ & ⋮ \\ ⋮ & ⋯ & ⋯ & ⋯ & ⋯ & ⋱ & ⋮ \\ {a}_{N , 1}^{k} & ⋯ & {a}_{N , j}^{k} & ⋯ & {a}_{N , i}^{k} & ⋯ & {a}_{N , N}^{k}\end{matrix} ] ,$$
where a_{j,i} represents any element in the adjacency matrix A, j represents a first number of the element a_{j,i}, and i represents a second number of the element a_{j,i}, a_{j,i} indicates whether j^{th} node xⱼ and an i^{th} node xᵢ in the graph G are connected with each other, and the value of the element a_{j,i} is 1 when the j^{th} node xᵢ and the i^{th} node xᵢ are connected with each other, otherwise the value of the element a_{j,i} 0;
$${a}_{j , i}^{k}$$
indicates whether the j^{th} node xⱼ and the l^{th} node xᵢ are connected with each other through at most k−1 intermediate nodes, when the j^{th} node xⱼ and the i^{th} node xᵢ are connected with each other through at most k−1 intermediate nodes, the value of
$${a}_{j , i}^{k}$$
is 1, and the i^{th} node xᵢ is a k-hop neighbor node of the j^{th} node x_{J}, otherwise, the value of
$${a}_{j , i}^{k}$$
is 0; and j^{th} row in the k-order adjacency matrix A^{k} is a row where the node xⱼ is located, and j^{th} column in the k-order adjacency matrix A^{k} is a column where the node xⱼ is located; and
writing the adjacency matrix A and k-order adjacency matrix A^{k} of the graph G into DDR4 storage outside FPGA; and providing a FIFO-cnt counter and six preprocessing units;
sub-step (3.2) selecting any six test nodes from the test set Tₑ, and allocating a corresponding preprocessing unit to any one test node, respectively; scanning, by each preprocessing unit, the row of the respective test node from the k-order adjacency matrix A^{k} of the graph G to obtain row data of the test nodes and to determine a number of k-hop neighbor nodes for the respective test node; and
sorting the obtained numbers of the k-hop neighbor nodes of the six test nodes in a descending order, wherein a test node with a larger number of k-hop neighbor nodes is given priority in sub-step (3.3), and when the number of k-hop neighbor nodes is the same, a test node with a smaller serial number is given priority in sub-step (3.3);
sub-step (3.3) setting eight segment traversal units, dividing evenly the row data obtained by scanning the test nodes into eight segments, distributing the eight segments to the eight segment traversal units in turn, wherein each segment traversal unit has a write initiation application and a write enable response; and controlling, by an arbiter, applications initiated by the eight segment traversal units for round-robin arbitration, traversing, by each segment traversal unit, the allocated row data, finding the test nodes corresponding to second numbers of all elements with an element value of 1 in the graph G as the k-hop neighbor nodes of the test nodes, to obtain the k-hop neighbor node set of the test nodes; and
intercepting the k-order adjacency matrix A^{k} of the graph G by the k-hop neighbor node set of the test nodes, comprising: intercepting the corresponding row data from the k-order adjacency matrix of the graph G according to the number of each k-hop neighbor node to obtain a row matrix of the test nodes; and intercepting the corresponding column data from the row matrix of the test nodes according to the number of each k-hop neighbor node to obtain the subgraph adjacency matrix of the test nodes;
sub-step (3.4) performing the sub-step (3.3) on the six test nodes in turn to obtain the corresponding k-hop neighbor node set and the subgraph adjacency matrix, respectively; and
sub-step (3.5) selecting any six test nodes from the remaining test nodes in the test set Tₑ, repeating the sub-step (3.1) to the sub-step (3.4) until each test node in the test set Tₑ obtains the respective k-hop neighbor node set and the respective subgraph adjacency matrix, and obtaining a subgraph adjacency matrix set
$$\{ {A}_{sub}^{1} , {A}_{sub}^{2} , … , {A}_{sub}^{q} , … , {A}_{sub}^{Q} \} ,$$
where
$${A}_{sub}^{q}$$
represents the subgraph adjacency matrix corresponding to the test node \tilde{x}_{q}.

5. The method for interpreting the graph neural network based on FPGA acceleration according to claim 4, wherein the step (4) further comprises the following sub-steps:
sub-step (4.1) when the number
$${N}_{q}^{k}$$
of k-hop neighbor nodes of any test node \tilde{x}_{q} in the test set is not more than m, performing a corresponding HN table operation on the subgraph adjacency matrix
$${A}_{sub}^{q}$$
of the test node \tilde{x}_{q}, comprising:
(c1) acquiring a connectivity result set of all permutations and combinations of nodes in the k-hop neighbor node set of the test node \tilde{x}_{q} in FPGA hardware to obtain a matrix P̅_{q};
(c2) optimizing the calculation of (H_{q})⁴ by taking (H_{q})⁴ as an iterative convergence value of H_{q}, wherein dividing (H_{q})⁴ into cubic sparse-dense matrix multiplication and quadratic dense matrix multiplication using an idempotent property, namely, (P̅_{q})²=P̅_{q} and (H_{q})²=(P̅_{q}M_{q})P̅_{q}(M_{q}P̅_{q}), of the matrix P̅_{q}, wherein the sparse-dense matrix multiplication assigns tasks to elements with an element value of 1 in a sparse matrix, and adopts direct static mapping from matrix rows to eight PEs to increase parallel calculation of the FPGA hardware, each PE is assigned multiple rows with intervals between them, and the elements with the element value of 1 are searched among the rows in a round-robin manner, to prevent the sparse matrix from gathering in some rows, and multiple rows of data to be processed are effectively connected; and
(c3) pre-calculating eigenvalue results of all node combination arrangements according to a node number in the subgraph adjacency matrix of the test node \tilde{x}_{q}, and splicing the eigenvalue results into an eigenvalue vector v̅_{q} according to an arrangement combination of single node, double nodes, . . . , and m nodes;
calculating the eigenvalue results of any node combination arrangement o by the following equation:
$$\overline{v} = [ f ( {G}_{sub}^{q} ) ] {\_y}_{q}^{*} \_o - {f\_y}_{q}^{*}$$
where
$$[ f ( {G}_{sub}^{q} ) ] {\_y}_{q}^{*} \_o$$
represents a probability average that all nodes in the node combination arrangement o are predicted to be
$${y}_{q}^{*} ; and {f\_y}_{q}^{*}$$
represents a probability average that all nodes in the graph G are predicted to be
$${y}_{q}^{*} ;$$
and
obtaining an HN value matrix vector \tilde{v}_{q} by \tilde{v}_{q} (H_{q})⁴*v̅_{q}, taking the first
$${N}_{q}^{k}$$
values in the HN value matrix vector \tilde{v}_{q} as HN values of
$${N}_{q}^{k}$$
nodes in the k-hop neighbor node set of the test node \tilde{x}_{q}, respectively, to obtain an HN table of the subgraph adjacency matrix
$${A}_{sub}^{q}$$
of the test node \tilde{x}_{q};
sub-step (4.2) when the number
$${N}_{q}^{k}$$
of k-hop neighbor nodes of any test node \tilde{x}_{q} in the test set is greater than m, sampling the subgraph adjacency matrix
$${A}_{sub}^{q}$$
of the test node \tilde{x}_{q} layer by layer on FPGA based on a central node, and generating a sampling graph adjacency matrix set
$$\{ {A}_{MC \_ 1}^{q} , {A}_{MC \_ 2}^{q} , ... , {A}_{{MC \_ N}_{q}^{k}}^{q} \}$$
of the test node \tilde{x}_{q}; and
performing a corresponding HN table operation for each sampling diagram adjacency matrix in the sampling diagram adjacency matrix set to obtain the HN table corresponding to each sampling diagram adjacency matrix; and a HN value of each node in the subgraph adjacency matrix
$${A}_{sub}^{q}$$
of the test node \tilde{x}_{q} being an average of the HN values in different sampling graph adjacency matrices, and obtaining the explanatory subgraph of the test node \tilde{x}_{q}; and
sub-step (4.3) repeating the sub-step (4.1) or the sub-step (4.2) for each test node according to the number of k-hop neighbor nodes of each test node in the test set, and generating the explanatory subgraph corresponding to each test node in the test set.

6. The method for interpreting the graph neural network based on FPGA acceleration according to claim 4, wherein the sub-step (4.2) specifically comprises the following sub-sub-steps:
sub-sub-step (4.2.1) when the number
$${N}_{q}^{k}$$
of the k-hop neighbor nodes of the test node \tilde{x}_{q} is greater than m, for the subgraph adjacency matrix
$${A}_{s u b}^{q}$$
of the test node \tilde{x}_{q}, traversing shortest path of the subgraph adjacency matrix
$${A}_{s u b}^{q}$$
of the test node \tilde{x}_{q} by taking the test node \tilde{x}_{q} as a target node;
sub-sub-step (4.2.2) while traversing the shortest path of the subgraph adjacency matrix
$${A}_{s u b}^{q}$$
of the test node \tilde{x}_{q}, generating synchronously the sampling graph node set to obtain the sampling graph adjacency matrix set
$$\{ {A}_{MC \_ 1}^{q} , {A}_{MC \_ 2}^{q} , … , {A}_{{MC \_ N}_{q}^{k}}^{q} \}$$
of the test node \tilde{x}_{q}; and
sub-sub-step (4.2.3) performing the corresponding HN table operation for each sampling diagram adjacency matrix in the sampling diagram adjacency matrix set to obtain the HN table corresponding to each sampling diagram adjacency matrix; and the HN value of each node in the subgraph adjacency matrix
$${A}_{sub}^{q}$$
of the test node \tilde{x}_{q} being an average of the HN values in different sampling graph adjacency matrices, and obtaining the explanatory subgraph of the test node \tilde{x}_{q}.

7. The method for interpreting the graph neural network based on FPGA acceleration according to claim 6, wherein the sub-sub-step (4.2.1) further comprises:
(a1) performing traversal initialization, comprising: initializing node on an FPGA to a list with all element values being 0 and a length of
$${N}_{q}^{k}$$
by
$$node = node ( 1 ) , … , node ( c ) , … , node ( {N}_{q}^{k} ) ] = [ 0 , … , 0 ] ,$$
identifying, by the list node, whether the target node z_{q} has been accessed, where node(c) represents the element value of a c^{th} element in the list node; initializing flag to a queue comprising only the number of the target node in the graph node set V by flag=[flag (1)]=[q′], storing, by the queue flag, the neighbor node numbers obtained by BFS after each node traversal, where flag(1) represents the element value of a first element in the list flag, and q′ represents the number of the target node \tilde{x}_{q} in the graph node set V; initializing node_flag to a list with an element value of 1 for a q^{th} element and element values of 0 for other elements as well as a length of
$${N}_{q}^{k}$$
by node_flag=[node_flag(1), . . . ,node_flag(c), . . . ,node_flag(7)], identifying, by the list node_flag, whether the target node \tilde{x}_{q} already exists in the flag, where node_fag(c) represents the element value of the c^{th} element in the list node_fag, and node_fag(q)=1; initializing node_f to a list with all element values being −1 and a length of
$${N}_{q}^{k}$$
by
$$node\_f = [ node\_f ( 1 ) , … , node\_f ( c ) , … , node\_f ( {N}_{q}^{k} ) ] = [ - 1 , … , - 1 ] ,$$
identifying, by the list node_f, a predecessor node of the node traversal process, where node_f(c) represents the element value of the c^{th} element in the list node_f; initializing bfs_cnt=0 to control a subscript address of the queue flag for each access; and initializing node_pate to a list containing
$${N}_{q}^{k}$$
sub-lists by
$$node\_pate = [ node\_pate [ 1 ] , … , node\_pate [ E ] , … , node\_pate [ {N}_{q}^{k} ] ] ,$$
where node_pate [E] represents an E^{th} sub-list in the list node_pate, and each sub-list comprises
$${N}_{q}^{k}$$
elements with all element values being 0, respectively;
(a2) after traversal initialization, performing access according to the value of bfs_cnt to obtain the element value of a bfs_cnt^{th} element in the listflag: flag(bfs_cnt); updating the list node, assigning the element value of a flag(bfs_cnt)^{th} element in the list node with 1, and taking a node x_{flag(bfs_cnt)} as a current traversal target node, and determining whether the element value of the flag(bfs_cnt)^{th} element in a list node_f is −1, when the element value is −1, predecessor node of the current traversal target node being invalid, and reading a flag(bfs_cnt)^{th} row of the subgraph adjacency matrix
$${A}_{s u b}^{q}$$
to obtain row data, and skipping to step (a3) to update limited node information; when the element value is not −1, the predecessor node of the current traversal target node being valid, and updating the list node_pate: registering the path information from the current traversal target node to the target node into the list node_pate, and reading the flag(bfs_cnt)^{th} row of the subgraph adjacency matrix
$${A}_{s u b}^{q}$$
to obtain row data, and skipping to step (a3) to update the limited node information; and
(a3) traversing the read row data for effective elements, comprising: reading the row data to obtain a second number of a first element with an element value of 1 as h, when the second number h is the same as the element value of any one element in the list flag, reading the row data to obtain the second number of a next element with an element value of 1; when the second number h is different from the element value of any one element in the list flag, updating the list flag: adding the second number h to the list flag to obtain the updated list flag is flag=[flag(1),fag(1)]=[M,h], and updating the list node_fag: giving the element value of the h^{th} element in the list node_fag to 1, and recording the predecessor node of a node xₕ as the current traversal target node and updating the list node_f assigning the element value of the h^{th} element in the list node_f to the number M of the current traversal target node, reading the row data to obtain the second number of the next element with an element value of 1, and repeating the above steps until the element with an element value of 1 is not capable of being read from the row data, and ending traversing; and
after traversing, updating the value of bfs_cnt by bfs_cnt=bfs_cnt+1; repeating step (a2) according to the updated value of bfs_cnt until the updated value of bfs_cnt is
$${N}_{q}^{k} + 1 ,$$
jumping to an idle state to complete the shortest path traversal of the subgraph adjacency matrix
$${A}_{sub}^{q}$$
of the test node \tilde{x}_{q} to obtain the updated list node_pate.

8. The method for interpreting the graph neural network based on FPGA acceleration according to claim 6, wherein the step (4.2.2) further comprises:
(b1) performing sample initialization, comprising: initializing node_out to a list comprising
$${N}_{q}^{k}$$
sub-lists by
$$node\_out = [ node\_out [ 1 ] , … , node\_out [ D ] , … , node\_out [ {N}_{q}^{k} ] ] ,$$
where node_out[D] represents a D^{th} sub-list in the list node_out, and each sub-list comprises m, respectively, and all element values are null; and initializing node_y to a list with all element values being 0 and a length of
$${N}_{q}^{k}$$
by
$$node\_y = [ node\_y ( 1 ) , … , node\_y ( c ) , … , node\_y ( {N}_{q}^{k} ) ] = [ 0 , … , 0 ] ,$$
where node_y(c) represents the element value of the c^{th} element in the list node_y;
(b2) after sampling initialization, detecting the number of elements in the list flag at any time, comprising: when detecting that the number of elements in the list flag is m, obtaining a set of m nodes closest to the test node \tilde{x}_{q}, and skipping to step (b3);
(b3) updating the list node_out to obtain the updated list node_out by node_out=[[x_{flag(1)}, x_{flag(2)}, . . . , x_{flag(m)}], . . . , [x_{flag(1)},x_{flag(2)}, . . . , x_{flag(m)}]];
(b4) updating the updated value of bfs_cnt at any time after traversing, wherein when the updated value of node_out is m+1, m nodes have been traversed in the traversal process of the shortest path; and skipping to step (b5);
(b5) updating the list node_y, comprising: covering each element value in the updated list node at this time after traversing with each element value in the list node_y;
(b6) after traversing the shortest path of the subgraph adjacency matrix
$${A}_{sub}^{q}$$
of the test node \tilde{x}_{q}, processing the updated list node_pate, comprising: assigning the element value of the D^{th} element in the D^{th} subgraph of the list node_pate with 1, and performing the above operations for each subgraph; and obtaining the number of the elements whose element value is 0 in the list node_y: u₁, . . . , u_{z}, . . . ;
performing sequentially the following processes on each obtained number: calculating the number of elements with an element value of 1 in a u_{z}^{th} row in the list node_pate as num_u_{z} corresponding to any number u_{z}; obtaining a set of samplable nodes, node_pate{u_{z}}′, of the node xᵤ_{_{z}} outside the shortest path node and closest to the test node \tilde{x}_{q} through combinatorial logic (node_pate{u_{z}}& node_y)∧node_y, where node_pate{u_{z}} represents the row data of the u_{z}^{th} row in the list node_pate, & represents an AND operator, and ∧ represents an XOR operator; reserving arbitrarily m-num_u_{z} elements from the samplable node set node_pate {u_{z}}′ of the node xᵤ_{_{z}}, to have an element value of 1, and covering the remaining nodes with the element value from 1 to 0, obtaining a second samplable node set node_pate{u_{z}}″ of the node xᵤ_{_{z}}, and performing an OR operation on the second samplable node set node_pate{u_{z}} and node_pate{u_{z}} to obtain a sampling node set node_pate{u_{z}} of the node xᵤ_{_{z}}; updating the list node_out: covering sequentially the number corresponding to the element with an value of 1 in the sampling node set of the node xᵤ_{_{z}}, with the number of each element in the u_{z}^{th} row of the list node_out; and
completing the processing of each obtained number to obtain a sampled list node_out; and
(b7) performing an adjacency matrix interception operation on the subgraph adjacency matrix
$${A}_{sub}^{q}$$
of the test node \tilde{x}_{q} by taking each row of data in the sampled list node_out as the sampling neighbor node set of the test node \tilde{x}_{q} to obtain
$${N}_{q}^{k}$$
sampling graph adjacency matrices, and obtaining the sampling graph adjacency matrix set
$$\{ {A}_{MC \_ 1}^{q} , {A}_{MC \_ 2}^{q} , … , {A}_{{MC \_ N}_{q}^{k}}^{q} \}$$
of the test node \tilde{x}_{q}.

9. A device for interpreting a graph neural network based on FPGA acceleration, comprising one or more processors for implementing the method for interpreting the graph neural network based on FPGA acceleration according to claim 1.

10. A non-transitory computer-readable storage medium on which a program is stored, wherein the program, when executed by a processor, is configured to implement the method for interpreting the graph neural network based on FPGA acceleration according to claim 1.
